(19) United States
(12) Patent Application Publication
(10) Pub. No.: US 2026/0103568 A1
(43) Pub. Date: Apr. 16, 2026

(54) POLYARYLETHERSULFONE COPOLYMER HAVING IMPROVED HYDROPHILICITY

(71) Applicant: SYENSQO SPECIALTYY POLYMRES USA, LLC, Alpharetta, GA (US)

(72) Inventors: Joel POLLINO, Johns Creek, GA (US); Matthew BOOHER, Canton, GA (US); Emanuele DI NICOLO', Gorla Minore (IT); Caroline GELLENE, Stamford, CT (US)

(21) Appl. No.: 19/115,806

(22) PCT Filed: Oct. 6, 2023
(86) PCT No.: PCT/EP2023/077667

§ 371 Date: Mar. 27, 2025

Related U.S. Application Data
(60) Provisional application No. 63/415,044, filed on Oct. 11, 2022.

(30) Foreign Application Priority Data
Feb. 17, 2023 (EP) 23157251.2

(51) Int. Cl. C08G 75/23; B01D 61/24; B01D 67/00; B01D 71/68; C08J 9/00; C08L 81/06; H01M 10/0565

(52) U.S. Cl. CPC C08G 75/23; B01D 67/0018; B01D 71/68; C08J 9/0095; C08L 81/06; H01M 10/0565; B01D 61/243; C08J 2201/0544; C08J 2381/06; C08J 2481/06; C08L 2203/02; C08L 2203/20; C08L 2205/025; H01M 2300/0082

(57) ABSTRACT

A polyarylethersulfone (‘PAES’) copolymer, a process for preparing the PAES copolymer, an article such as a film, fiber, membrane or a part thereof comprising the PAES copolymer, the use of the PAES copolymer in the preparation of an article, a polymer solution comprising the PAES copolymer, and a method for using such article for aqueous medium treatment. The PAES copolymer is a random polymer which comprises at least two types of recurring units, one of which being derived from condensation of a diol and a dihalogenated alkylene oxide, while the other type of recurring units is derived from condensation of the same diol and a dihalodiphenylsulfone. The diol may be aromatic or alicyclic. The dihalogenated alkylene oxide preferably has at most 9 carbon atoms and/or at most 4 oxygen atoms.

### CROSS-REFERENCE TO RELATED APPLICATIONS

This application claims priority to U.S. patent application No. 63/415,044 filed on Oct. 11, 2022 and European patent application No. 23157251.2 filed on Feb. 17, 2023, the whole content of these applications being incorporated herein by reference for all purposes.

### TECHNICAL FIELD

The present disclosure relates to a polyarylethersulfone (“PAES”) copolymer having improved hydrophilicity, to a process for manufacturing such PAES copolymer, to articles, in particular films, hollow tubes, hollow fibers or porous membranes, comprising such PAES copolymer, and to the use of the PAES copolymer for preparing such articles.

### BACKGROUND ART

Poly(arylethersulfone) (PAES) polymers are also high performance polymers with high mechanical strength and high thermal stability; they are used in a variety of industrial applications. Their chemical, thermal, and mechanical resistance, combined with its excellent hydrolytic stability and relatively inexpensive production costs, make it ideal for widespread use in fabrication of membranes, in particular porous membranes, e.g., porous hollow-fiber polymeric membranes. Porous hollow-fiber polymeric membranes are employed in many applications such as hemodialysis, ultrafiltration, nanofiltration, reverse osmosis, gas separation, microfiltration, desalination via membrane distillation, and pervaporation. For many of these applications, membranes with optimal selectivity as well as chemical, thermal and mechanical stability are desirable.

Membranes made from PAES polymers are hydrophobic in nature and therefore endowed with water repellency, low water permeability and subject to fouling of particles, proteins at their surface. Hydrophobicity impedes water to penetrate into a porous PAES membrane and therefore water permeability requires higher pressure and consumes more energy. Furthermore, the intrinsic hydrophobicity of PAES polymers makes membranes made therefrom prone to fouling which negatively impacts their performance. Fouling is caused by hydrophobic interactions between membrane materials and foulants (e.g., microorganisms, proteins, or organic matter) originating from an aqueous fluid to be treated though the membrane. In particular, fouling is initiated by the adsorption of foulants onto the membrane surface and/or its internal porous structure, resulting in pore blocking, cake layer formation, and/or biofilm formation. Membrane fouling not only reduces temporarily or permanently the flux of permeation of water through the membrane, e.g., in ultrafiltration or microfiltration processes, thereby decreasing membrane permeability and overall lifetime, but also increases maintenance costs due to extensive and frequent cleaning to remove foulants.

While PAES polymers have many advantages, and good physical properties, it is sometimes desirable to tune one or more properties to improve performance in specific applications (for example, hemodialysis, bio-separation or water filtration), such as becoming less susceptible for fouling, having an increased hydrophilic nature and/or having an improved biocompatibility.

Since most of the commercial pressure driven membranes are made of hydrophobic polymers including polyethersulfone (PES) and polysulfone (PSU), enhancing surface hydrophilicity can be achieved by increasing the density of the hydrophilic groups at the membrane surface. It is generally accepted that an increase of the hydrophilicity of PAES membranes offers better fouling resistance because most of proteins and other foulants are hydrophobic in nature.

Several strategies have been employed to make the porous PAES membrane hydrophilic and thus rendering said membrane highly water permeable and highly resistant to fouling. Among approaches that have been pursued, one can cite approaches based on grafting hydrophilic species on the surface of membranes, incorporation of hydrophilic co-monomers in polymer chain of main polyarylethersulfone polymer, incorporation of hydrophilization additives, etc. . . . These approaches are reviewed e.g. in Rana et al., Surface Modifications for Antifouling Membranes, Chemical Reviews, 2010, Vol. 110, No. 4, p. 2448-2471.

For example the PAES may be blended with a highly hydrophilic polymer such as polyvinylpyrrolidone or polyethylene oxide to increase the hydrophilicity of a PAES-based membrane, while the PAES may be blended with a zwitterionic polymer in order to impart antifouling properties to the membrane. Even though this approach may be straightforward, there are serious limitations as typically the two or more polymers which are blended are not compatible which results in gross macro-phase separation in the final polymeric blend. Further since these polymers are simply physical mixtures, the resultant polymeric blend may change its composition over time after membrane use, and thus also its performance due to the loss of one of the polymers by way of diffusion during operation of the membrane.

Another approach to avoid such behavior is to covalently link a PAES homopolymer and the other hydrophilic polymer so that the resulting material has a robust composition and does not substantially change during the application. Modification of hydrophilicity may be also achieved by combining two homopolymers to make block copolymers that possess the combination of intrinsic properties of each individual homopolymer. In membrane applications, a PAES homopolymer can be covalently linked to a hydrophilic homopolymer to synthesize a new PAES-hydrophilic block copolymer possessing superior membrane performance owing to the enhanced wettability caused by the hydrophilic component while retaining the mechanically robust and amorphous pore structure of the PAES component.

Several methods for making such block aromatic sulfone-based polymers are exemplified in the following references.

WO2006/12453A1 (Solvay) describes block copolymer comprising: at least one block of a polymer comprising at least 50 mole % of recurring units (R1) formed by the polycondensation reaction between at least one aromatic dihalocompound comprising at least two —S(═O)₂— groups and at least three aromatic rings, and at least one aromatic diol (block (A)), and at least one block of a polymer comprising at least 50 mole % of recurring units (R2) formed by the polymerization of at least one alkylene oxide (block (B)). Process to synthesize said block copolymer. WO'453 also describes an article, in particular membrane, comprising such block copolymer and a use of such membrane for purifying a liquid or for separating gases.

US2016/07850A1 (Weber et al.) describes a method for preparing PAES-polyalkylene oxide block copolymer comprising in polymerized form an aromatic dihalogen compound, an aromatic dihydroxyl compound, a polyalkylene oxide comprising at least two hydroxyl groups (generally 1 to 500 alkylene oxide units; most preferably 10 to 80 units, Mₙ>200 g/mol), an aprotic solvent and a metal carbonate. US'850 prescribes the absence of an azeotropic agent in the polymerization, as it is stated that the absence of an azeotropic agent in the synthesis is correlated with longer polyarylether blocks and therefore higher Tgs versus comparative examples.

US2013/035457 (Weber et al.) describes a two-step process for preparing a block copolymer, wherein an HO-terminated polyaryleneether (macroinitiator) reacts as the phenoxide with a monomeric alkylene oxide to give a block copolymer comprising polyaryleneether with poly(alkylene oxide). US'457 also relates to a triblock polymer with polyalkylene oxide-polyarylether-polyalkylene oxide blocks.

Zhang, et al (1994) in “Synthesis and characterization of poly(ethylene oxide-co-ethylene sulfone)s and their precursors: poly(ethylene oxide-co-ethylene sulfide)s”, Journal of Polymer Sciences: Part A: Polymer Chemistry, vol. 32, pp. 1323-1330, describes the use of 1,2-bis(2-chloroethoxy)ethane (dichloro ethylene oxide) in the synthesis of poly(ethylene oxide-co-ethylene sulfone). The polymer structure does not contain any aromatic cycles.

Gronwald, et al. (2020) in “Hydrophilic poly(phenylene sulfone) membranes for ultrafiltration,” Separation & Purification Technology, vol 250, p. 117107 explains that the lower hydrophilicity of PPSU, which affects pore size and membrane manufacture, versus PESU, prevents the use of PPSU for ultrafiltration membranes. The paper describes the synthesis of blocky PPSU-poly(alkylene oxide) polymers as dope solution additives for PPSU membranes with enhanced hydrophilicity and hydraulic permeance and reduced fouling. The polymerization products of DCDPS and biphenol with three different commercial poly(alkylene oxides) having one or two hydroxyl end groups and average molecular weight of ˜3780 to 12 400 g/mol are described. The blocky oligomers, with PPSU block size ranging from 2000 to 8000 g/mol, are introduced as additives at ˜9 wt. % of membrane polymer content.

However the making of block polymers requires generally several synthesis steps involving the formation of the various blocks.

Another approach to modify the hydrophilicity may be achieved by making PAES copolymers using a hydrophilic monomer, which could lead to the incorporation of hydrophilic moieties in the PAES main chain and/or side chains. This approach for making such PAES copolymers is exemplified in the following references.

U.S. Pat. No. 4,503,212 (Dexheimer) describes the use of bisphenol S and ethylene oxide or propylene oxide in the preparation of sulfone polyethers for use as thermally stable lubricants for fibers and rubber. Such process is based upon the ring opening polymerization of one or more alkylene oxides initiated by the salt of bisphenol S. The mole ratio of alkylene oxide to bisphenol S ranges from about 12 to 200 and each bisphenol S is linked to an aliphatic polyether block of varying lengths. US'212 does not use a dihalogenated monomer.

JP2008266325A (API Corp. & JUJO PAPER, Co. Ltd) relates to the use of bisphenol S and 1,2-bis(2-chloroethoxy)ethane (dichloro ethylene oxide) in the synthesis of diphenylsulfone derivatives. Such polymers are used as thermosensitive recording material and present improved properties for storage stability. JP'325 only uses two monomers for the polymer synthesis.

KR20160082913A (Samyang Corp.) relates to a copolymer prepared from the polymerization of bisphenol A, ethoxylated isosorbide and DCDPS. KR'913 uses two dihydroxy monomers in which the ethoxylated isosorbide is selected to increase hydrophilicity, but only uses one dihalogenated monomer for the polymer synthesis.

WO2018131381A1 (Toray) relates to an epoxy group-terminated polysulfide/polythioether. The tri-functional core of the polymer is formed by reaction of 1,2,3-trichloropropane and 1,2-bis(2-chloroethoxy)ethane with Na(SH) and Na₂(Sₓ). The thioether linkages are reacted with 2-(dichloromethyl)oxirane and bisphenol A to give terminal epoxy groups. WO'381 does not use a dihydroxy monomer.

It is therefore desirable to develop polyarylethersulfone polymers with increased hydrophilicity, having anti-fouling behavior and which does not leach the hydrophilic component over time during use in an article containing it, such as a highly permeable porous membrane. Said membrane should show high thermal and chemical stabilities which can ensure durable properties.

It is also desirable to develop a polyarylethersulfone polymer as dope solution additive for PAES membranes e.g., PES, PSU membranes, into which the additive is dispersed, such PAES membranes having high mechanical, thermal and chemical stabilities, with enhanced hydrophilicity, hydraulic permeance and reduced fouling. This polymer additive has to be easily and durably incorporated in the PAES polymer membrane in order to enhance their hydrophilicity, water permeability and anti-fouling behavior on the long term without impairing inherent properties of PAES polymers which are, high mechanical, thermal and chemical properties. In addition, the polymeric additive has to be a very efficient hydrophilization agent in order to be used sparingly, thus avoiding any detrimental effect due to their presence in too large amount on the mechanical, thermal and chemical resistance of the porous PAES membrane.

### SUMMARY OF INVENTION

The present invention thus relates to a new polyarylethersulfone [hereinafter “PAES”] copolymer with improved hydrophilicity and biocompatibility based upon copolymerization of at least one diol and two halogenated monomers: a dichloride of a monomer containing alkylene oxide and a dihalodiphenyl sulfone. The diol may be aromatic or alicyclic. The halogenated monomer containing the alkylene oxide contains at least one group represented by formula —(CHR_{I})_{y}O— in which R_{I} is H or an alkyl and y may be from 1 to 5. The PAES copolymer according to the invention is preferably a random polymer which is made in a single-step polymerization process, meaning that all monomers are present in a reaction mixture to form the main polymeric chain of the PAES copolymer. The PAES copolymer of the present invention is particularly suitable for use as a water-based membrane or membrane additive.

A first aspect of the present invention thus is directed to a PAES copolymer comprising collectively at least 80 mol. % of two distinct recurring units (R_{AO}) and (R_{PAES}) described hereinafter, said mol. % being based on the total number of moles of recurring units in said copolymer. Preferably, at least 50 mol. % of recurring units in the PAES copolymer are the recurring units (R_{PAES}).

The recurring units (R_{AO}) may be units represented by any formula selected from the group consisting of formulae (M1), (M′1), (M1a) to (M1i) being described hereinafter, and the recurring units (R_{PAES}) may be units represented by any formula selected from the group consisting of formulae (N), (N′), (N″) described hereinafter.

A second aspect of the present invention is directed to a process for making a PAES copolymer comprising reacting in a reaction mixture comprising a polar aprotic solvent and in the presence of an alkali metal carbonate, a monomer mixture which contains at least one dihaloalkylene oxide compound [dihalo monomer (AO), hereinafter], at least one dihaloaryl sulfone compound [dihalo monomer (AS), hereinafter] and at least one dihydroxy compound [dihydroxy monomer (B), hereinafter], wherein
the monomer mixture contains at least 4 mol. %, or at least 5 mol. %, or at least 6 mol. %, or at least 8 mol. %, or at least 10 mol. %, or at least 12 mol. %, and up to 50 mol. %, or at most 40 mol. %, or at most 30 mol. %, or at most 25 mol. %, of the dihalo monomer (AO), said mol. % being based on the combined numbers of moles of dihalo monomers (AO) and (AS);
the overall amount of halo-groups and hydroxyl-groups of the monomers in the monomer mixture is substantially equimolecular; and
the amount of the alkali metal carbonate used in the reaction mixture, when expressed by the ratio of the equivalents of alkali metal (Me) per equivalent of hydroxyl group (OH) in the monomer (B) [eq. (Me)/eq. (OH)] is greater than 1, preferably at least 1.05 and optionally up to 2, or up to 1.5, or up to 1.3.

The at least one dihalo (AO) monomer in the reaction mixture contains at least one alkylene oxide group represented by formula —(CHR_{I})_{y}O— in which R_{I} is H or an alkyl, preferably H or methyl; and y may be an integer of at least 2 and optionally at most 5; more preferably, y equals to 2 and at least one R_{I} is H. The at least one dihalo (AO) monomer in the reaction mixture preferably contains at least 2 and optionally at most 5 of such alkylene oxide groups. The dihalo (AO) monomer may have from 5 to 9 carbon atoms in total. The dihalo (AO) monomer may have from 1 to 4 oxygen atoms in total.

The at least one dihalo (AO) monomer in the reaction mixture is preferably at least one compound represented by a formula selected from the group consisting of formulae (I), (Ia), (Ib), (Ic), (Id), (Ie), (If), (Ig), (Ih) and/or (Ii), such formulae being described hereinafter.

The at least one dihalo (AS) monomer in the reaction mixture is of formula (V) being described hereinafter.

The at least one dihydroxy (B) monomer in the reaction mixture may be selected from the group consisting of:
tetramethyl bisphenol F,
at least one 1,4:3,6-dianhydrohexitol, preferably isosorbide;
at least one alicyclic diol,
at least one aromatic diol, preferably of formula (VI) being described hereinafter, more preferably selected from 4,4′-biphenol, Bisphenol S and/or Bisphenol A; and
any combination thereof.

A third aspect of the present invention is directed to a PAES copolymer made by the process according to the second aspect.

A fourth aspect of the present invention is directed to the use of the PAES copolymer according to the present invention to make a non-porous article, such as a dense (thick or thin) film or a tube, comprising a polymer solution casting or polymer melt processing method. A non-porous film may be referred to as a “dense” film. The PAES copolymer may be the sole polymer in the polymer solution or melt to make the non-porous article or the non-porous article may further comprise at least one other polymer.

A fifth aspect of the present invention is directed to the use of the PAES copolymer according to the present invention to make a porous article, such as porous film, hollow fiber, hollow tube or porous membrane, or a method to make such a porous article, using a phase inversion technique selected from nonsolvent induced phase separation or thermally induced phase separation. Such a use or method comprises casting or spinning a polymer dope solution comprising the PAES copolymer, a solvent, optionally a co-solvent and optionally at least one pore forming agent, into such a porous article, which is then cooled or contacted with a non-solvent to induce phase separation. The PAES copolymer may be the sole polymer in the polymer dope solution; or the dope solution may further comprise at least one other polymer.

A sixth aspect of the present invention is directed to an article, preferably a fiber, film, tube, membrane, or a part thereof such as a membrane layer or coating, such an article comprising the PAES copolymer according to the present invention. The article may be porous or non-porous. A porous article may be used for medical applications such as hemodialysis membranes or for aqueous medium or water filtration, such as reverse osmosis membranes, ultrafiltration membranes, microfiltration membranes, nanofiltration membranes, and/or ion-exchange membranes. The article may be used for solid state battery applications, such as polymer electrolyte membranes or polymeric or solid state electrolytes. The PAES copolymer may the sole polymer in the article or the article may further comprise at least one other polymer.

A seventh aspect of the present invention is directed to a polymer solution comprising the PAES copolymer according to the present invention. Such a polymer solution is particularly suitable for forming a film, fiber, tube, membrane, or a part thereof (such as a membrane layer or coating).

An eighth aspect of the present invention is directed to a method for purifying an aqueous medium, such as water, an aqueous solution (e.g., alkaline), a biological fluid (e.g., blood, plasma or serum) and/or food product (e.g., fruit juice, milk, beer), said method comprising at least a filtration step through a porous article, such as a porous membrane, hollow fiber(s), hollow tube(s) or porous film(s), such porous article comprising the PAES copolymer according to the present invention.

A ninth aspect of the present invention is directed to a method for improving the flexibility of a high-Tg aromatic sulfone polymeric material, preferably having a Tg≥180° C. and preferably selected from the group consisting of polysulfone (PSU), polyphenylsulfone (PPSU), polyethersulfone (PES), any copolymers thereof, or any blends thereof. Such a method comprises blending the PAES copolymer according to the present invention with the high-Tg bulk aromatic sulfone polymer to form a polymeric blend having a higher flexibility than the aromatic sulfone polymeric material. Such polymeric blend is preferably used in forming a porous article suitable for filtration, such as porous membrane, hollow fiber(s), hollow tube(s), or porous film. The higher flexibility means that upon bending of the polymeric blend the ductility is increased (less brittle material) and the modulus is decreased (less stiff) compared to the bulk sulfone polymer.

### DESCRIPTION OF PREFERRED EMBODIMENTS OF THE PRESENT INVENTION

In the present application:
any description, even though described in relation to a specific embodiment, is applicable to and interchangeable with other embodiments of the present disclosure, and each embodiment thus defined may be combined with another embodiment, unless otherwise indicated or clearly incompatible;
where an element or component is said to be included in and/or selected from a list of recited elements or components, it should be understood that in related embodiments explicitly contemplated here, the element or component can also be any one of the individual recited elements or components, or can also be selected from a group consisting of any two or more of the explicitly listed elements or components; any element or component recited in a list of elements or components may be omitted from such list;
any recitation herein of numerical ranges by endpoints includes all numbers subsumed within the recited ranges as well as the endpoints of the range and equivalents;
the term “comprising” (or “comprise”) includes “consisting essentially of” (or “consist essentially of”) and also “consisting of” (or “consist of”);
the use of the singular ‘a’ or ‘one’ herein includes the plural unless specifically stated otherwise; and
it should be understood that the elements, properties and/or the characteristics of a (co)polymer, product or article, a process or a use, described in the present specification, may be combined in all possible ways with the other elements, properties and/or characteristics of the (co)polymer, product or article, process or use, explicitly or implicitly, this being done without departing from the scope of the present description.

The term “consisting essentially of” in relation to a composition, product, polymer, solution, process, method, etc is intended to mean that any additional element or feature which may not be explicitly described herein and which does not materially affect the basic and novel characteristics of such a composition, product, polymer, solution, process, method, etc can be included in such an embodiment.

In the present disclosure, the term “recurring unit” designates the smallest unit of a PAES polymer which is repeating in the chain and which is composed of a condensation of a diol compound and a dihalo compound. The term “recurring unit” is synonymous to the terms “repeating unit” and “structural unit”.

As used herein, the term “homopolymer” encompasses a polymer which only has one type of recurring unit.

As used herein, the term “copolymer” encompasses a polymer which may have two or more different types of recurring units.

The term “solvent” is used herein in its usual meaning that, it indicates a substance capable of dissolving another substance (solute) to form a uniformly dispersed mixture at the molecular level. In the case of a polymeric solute it is common practice to refer to a solution of the polymer in a solvent when the resulting mixture is transparent and no phase separation is visible in the system. Phase separation is taken to be the point, often referred to as “cloud point”, at which the solution becomes turbid or cloudy due to the formation of polymer aggregates.

The term “membrane” is used herein in its usual meaning, is a separation article. That is to say it refers to a discrete, generally thin, interface that moderates the permeation of chemical species in contact with it. This interface may be molecularly homogeneous, that is, completely uniform in structure (dense or non-porous membrane), or it may be chemically or physically heterogeneous, for example containing voids, holes or pores of finite dimensions (porous membrane). A porous membrane generally has an outer surface and inner surfaces inside pores with which chemical species come in contact.

The weight average molecular weight (M_{w}) and the number average molecular weight (Mₙ) can be estimated by gel-permeation chromatography (GPC), preferably calibrated with polystyrene standards. The mobile phase may be selected from any solvent for the PAES copolymer described herein, such as methylene chloride, N-Methyl-2-pyrrolidone (NMP), sulfolane, or N,N′-dimethylacetamide (DMAc), preferably methylene chloride. The polydispersity index (PDI) is hereby expressed as the ratio of weight average molecular weight (M_{w}) to number average molecular weight (Mₙ).

As used herein, a polyethersulfone (PES) denotes any polymer comprising at least 50 mol. %, at least 60 mol. %, at least 70 mol. %, at least 80 mol. %, at least 90 mol. %, at least 95 mol. %, or at least 99 mol. % of recurring units (R_{PES}) of formula (J):

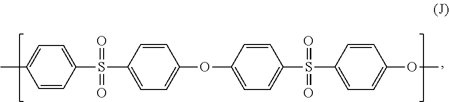

(the mol. % being based on the total number of moles of recurring units in the PES polymer). PES can be prepared by known methods and is notably available as VERADEL® PES from Solvay Specialty Polymers USA, L.L.C.

As used herein, a polysulfone (PSU) denotes any polymer comprising at least 50 mol., at least 60 mol. %, at least 70 mol. %, at least 80 mol. %, at least 90 mol. %, at least 95 mol. %, or at least 99 mol. % of recurring units (R_{PSU}) of formula (K):

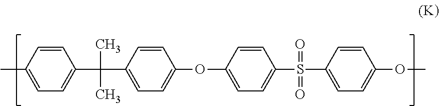

(the mol. % being based on the total number of moles of recurring units in the PSU polymer). PSU can be prepared by known methods and is notably available as Udel® PSU from Solvay Specialty Polymers USA, L.L.C.

As used herein, a polyphenylsulfone (PPSU) denotes any polymer comprising at least 50 mol. %, at least 60 mol. %, at least 70 mol. %, at least 80 mol. %, at least 90 mol. %, at least 95 mol. %, or at least 99 mol. % of recurring units (R_{PPSU}) of formula (L):

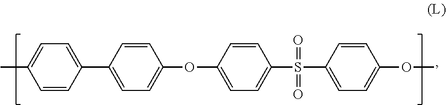

(the mol. % being based on the total number of moles of recurring units in the PPSU polymer). PPSU can be prepared by known methods and is notably available as RADEL® PPSU from Solvay Specialty Polymers USA, L.L.C.

The following advantages of the present invention are realized:
1) a ‘one-pot’ process in which the PAES copolymer synthesis is carried out in a single polymerization unit operation is simpler to operate;
2) it provides an easy way to tune the hydrophilicity of the PAES copolymer of the invention by controlling the amount of halogenated alkylene oxide comonomer used in the reaction mixture so as to control the water solubility of the PAES copolymer. Hydrophilicity and water solubility are especially important parameters to control, because, a) a too hydrophilic polymer may lead to its leaching from a membrane during use, and b) a too hydrophilic polymer may pose some challenges for polymer isolation via coagulation;
3) it provides an easy way to improve the flexibility of a bulk aromatic sulfone polymer by adding an amount of halogenated ethylene oxide comonomer in the reaction mixture during its polymerization to make a lower-Tg aromatic sulfone copolymer. A higher flexibility means that the ductibility upon bending of the copolymer is improved (less brittle material) compared to the sulfone polymeric polymer without inserting the halogenated alkylene oxide in the polymer chain;
4) in contrast to processes found in the prior art where an alkylene oxide of general formula HO-AO-OH is used as reactant in the manufacture of aromatic sulfone polymers, the process of the present invention wherein the alkylene oxide moiety reactant (AO monomer in the present reaction mixture) is an aliphatic halogen (e.g., Cl—CH₂—CH₂—O—CH₂—CH₂—O—CH₂—CH₂—CI of formula (Ia)) possesses a distinct advantage in the ability of the polymerization reaction to efficiently build molecular weight. This is important because molecular weight is proportional to viscosity and retaining viscosity is desirable particularly for membrane fabrication processes. Without wishing to be limited by such theory, it is generally understood that aliphatic halogens react with alcohol nucleophiles via a well-known nucleophilic substitution (SN2) mechanism. Such a reaction is both high yielding and rapid under the reaction conditions used to produce aromatic sulfone polymers. In contrast, when an aliphatic HO-AO-OH compound (e.g., triethyeleneglycol) is used as reactant, the reaction mechanism is based on a nucleophilic aromatic substitution (SNAr) because the HO-AO-OH is acting as a nucleophile. Such a SNAr reaction between aliphatic alcohols and aromatic halide leaving groups under the same reaction conditions used to produce aromatic sulfone polymers is comparatively lower yielding and slow. Thus, in the present invention, when selecting the alkylene oxide monomer as an aliphatic AO halogen (rather than an aliphatic AO alcohol), the polymerisation reaction relies on the SN2 mechanism (rather than SNAr) to form the aromatic-O—CH₂ ether bond, such a mechanism being higher yielding and faster under polymerization conditions at building molecular weight of the PAES copolymer.

Hence the present invention provides a way to achieve a tunable hydrophilicity and/or an increased flexibility of the PAES copolymer in a single-step polymerization process that builds PAES molecular weight and maintains it.

### PAES Copolymer

The first aspect of the present invention relates to a PAES copolymer which comprises collectively at least 80 mol. %, or at least 85 mol. %, or at least 90 mol. %, or at least 95 mol. %, or at least 97 mol. %, or at least 98 mol. %, or at least 99 mol. %, of two different recurring units (R_{AO}) and (R_{PAES}), said mol. % being based on the total number of moles of recurring units in the PAES copolymer. The PAES copolymer may consist essentially of the recurring units (R_{AO}) and (R_{PAES}).

The expression “PAES copolymer” is used, within the frame of the present invention for designating copolymers comprising ‘sulfone’ recurring units derived from a dihalogenated aromatic sulfone monomer, generally as major recurring units. Therefore, the PAES copolymer is generally a polymer comprises at least 50% by moles of the sulfone recurring units (R_{PAES}), said mol. % being based on the total number of moles of all recurring units in the PAES copolymer.

The PAES copolymer comprises at least 4 mol. %, or at least 5 mol. %, or at least 6 mol. %, or at least 8 mol. %, or at least 10 mol. %, or at least 12 mol. %, and up to 50 mol. %, or at most 40 mol. %, or at most 30 mol. %, or at most 25 mol. %, of the recurring units (R_{EO}), said mol. % being based on the combined numbers of moles of recurring units (R_{AO}) and (R_{PAES}).

The recurring units (R_{AO}) in the PAES copolymer may be selected from units of formulae (M1) and/or (M′1):

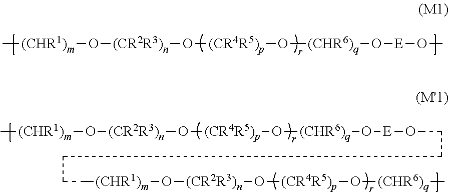

In formulae (M1) and (M′1), each of R¹, R², R³, R⁴, R⁵ and R⁶ is independently H or CH₃.

In formulae (M1) and (M′1), each of m and q is independently an integer of at least 2 and optionally at most 5, preferably equals to 2, with the proviso that at least one R¹ is H and at least one R⁶ is H.

In formulae (M1) and (M′1), each of n and p is independently an integer of at least 1 and optionally at most 5, preferably equals to 1 or 2, with the proviso that when n=2, at least one R2 or R³ is H; and when p=2, at least one R⁴ or R⁵ is H.

In formulae (M1) and (M′1), r is 0, 1, 2 or 3.

In formulae (M1) and/or (M′1), m, n and q are preferably 2 and r preferably equals 0.

In formulae (M1) and/or (M′1), when r is 1, 2, or 3, then p is preferably 2.

The alkylene oxide moiety of the recurring units (R_{AO}) of formulae (M1) and/or (M′1) in the PAES copolymer, which is represented by:

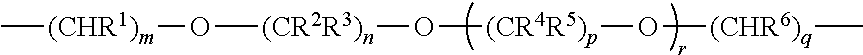

preferably has at least 5 carbon atoms and at most 9 carbon atoms and/or at least 2 oxygen atoms and at most 4 oxygen atoms.

The recurring units (R_{AO}) in the PAES copolymer may be preferably any unit represented by a formula selected from the group consisting of formulae (M1a) to (M1i):

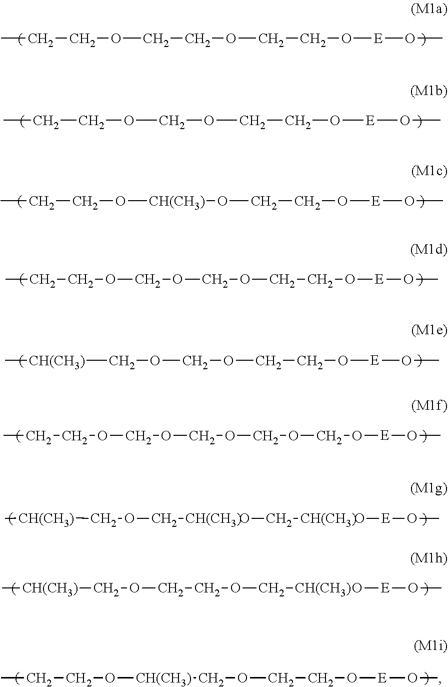

more preferably selected from formulae (M1a), (M1b), (M1g), (M1h) and/or (M1i), yet more preferably selected from formulae (M1a), (M1g), (M1h) and/or (M1i), even more preferably selected from formula (M1a).

In any of the formulae (M1), (M′1), (M1a) to (M1i), -E- is derived from at least one dihydroxy (B) monomer selected from the group consisting of:
tetramethyl bisphenol F,
at least one 1,4:3,6-dianhydrohexitol;
at least one alicyclic diol;
at least one aromatic diol; and
any combination thereof.

In any of the formulae (M1), (M′1), (M1a) to (M1i), -E- is preferably represented by at least one of following formulae (E1) to (E7):

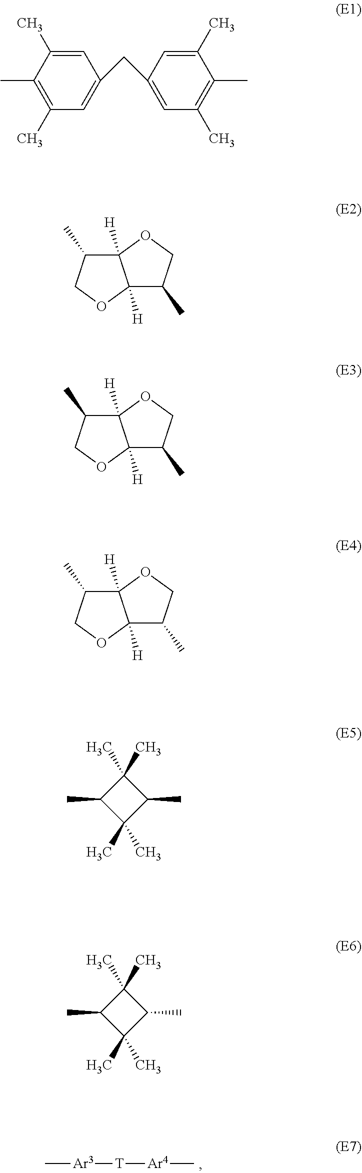

wherein
T in formula (E7) is selected from the group consisting of a bond, —SO₂—, —C(CH₃)₂—, —C(CF₃)₂—, —C(CCl₃)₂—, —C(═CCl₂)—, —CH₂—, —O—, —C(O)—, —C(CH₃)(CH₂CH₂COOH)—, —S—, —SO—, and any combination thereof, preferably selected from the group consisting of a bond, —SO₂—, —C(CH₃)₂—, —C(CF₃)₂—, —C(O)—, and any combination thereof, more preferably selected from the group consisting of a bond, —SO₂—, —C(CH₃)₂—, and any combination thereof, and
Ar³ and Ar⁴ in formula (E7), equal to or different from each other and at each occurrence, are independently aromatic moieties complying with any of the following formulae (J), (J′) and (J″), preferably complying with the formula (J):

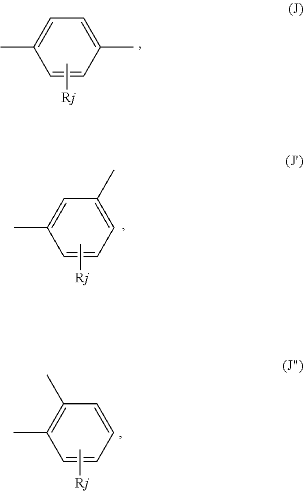

in which each R in formulae (J), (J′) and (J″), equal to or different form each other, is selected from the group consisting of halogen, alkyl, alkenyl, alkynyl, aryl, ether, thioether, carboxylic acid, ester, amide, imide, alkali or alkaline earth metal sulfonate, alkyl sulfonate, alkali or alkaline earth metal phosphonate, alkyl phosphonate, amine and quaternary ammonium; and
in which each j, equal to or different from each other, are independently 0, 1, 2, 3 or 4, preferably j=0 or 1.

In any of the formulae (M1), (M′1), (M1a) to (M1i), -E- is more preferably represented by a formula selected from the formulae (E1) to (E6) described previously, and following formulae (E7a), E7b) and (E7c):

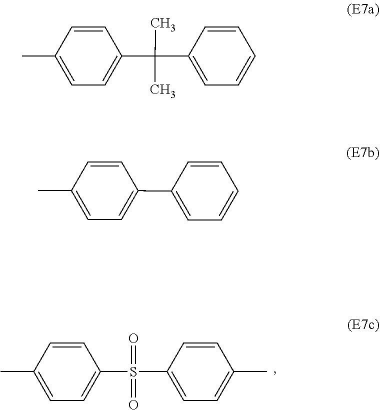

yet more preferably represented by a formula selected from the formulae (E1), (E7a), E7b) and/or (E7c).

The recurring units (R_{PAES}) in the PAES copolymer is represented by formula (N):

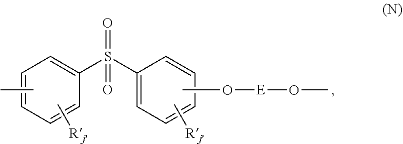

wherein
each R′ in formula (N), equal to or different form each other, is selected from the group consisting of halogen, alkyl, alkenyl, alkynyl, aryl, ether, thioether, carboxylic acid, ester, amide, imide, alkali or alkaline earth metal sulfonate, alkyl sulfonate, alkali or alkaline earth metal phosphonate, alkyl phosphonate, amine and quaternary ammonium;
each j′ in formula (N), equal to or different from each other, are independently 0, 1, 2, 3 or 4, preferably j′=0 or 1; and
-E- in formula (N) is the same as described for the recurring units (R_{AO}) represented by any of the formulae (M1), (M′1), (M1a) to (M1i).

The recurring units (R_{PAES}) in the PAES copolymer may be preferably represented by formula (N′):

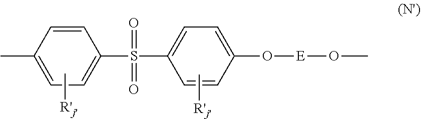

wherein j′=0 or 1 for each R′, and when j′=1, R′ is selected from the group consisting of alkali metal sulfonates, alkaline earth metal sulfonates and alkyl sulfonates, and wherein -E- in formula (N′) is the same as described for the recurring units (R_{AO}) represented by any of the formulae (M1), (M′1), (M1a) to (M1i).

The recurring units (R_{PAES}) in the PAES copolymer may be such that in some recurring units (R_{PAES}) of formulae (N) or (N′), some R′ are selected from sulfonic acid groups; alkali or alkaline earth metal sulfonate groups; and/or alkyl sulfonate groups, with its corresponding j′=1, while in other recurring units (R_{PAES}) of formulae (N) or (N′), j′=0 (i.e., the phenyl groups are not substituted). A phenyl ring which is optionally substituted with such R′ and j′=1 is preferably connected to the —SO₂— linking group of the recurring units (R_{PAES}).

The recurring units (R_{PAES}) in the PAES copolymer may preferably be such that each j and j′ are zero, meaning that no phenyl groups are substituted in formula (N) or (N′). In such instances, the recurring units (R_{PAES}) in the PAES copolymer are more preferably represented by formula (N″):

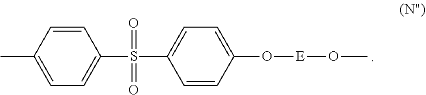

In the recurring units (R_{PAES}) of the PAES copolymer, -E- in formula (N), (N′) or (N″) may be represented by at least one of the formulae (E1) to (E7) described herein, preferably represented by at least one of the formulae (E1) to (E6), (E7a), E7b) and (E7c) described herein, more preferably represented by at least one of the formulae (E1), (E7a), (E7b) and (E7c).

Preferably, the PAES copolymer comprises collectively at least 80 mol. %, or at least 85 mol. %, or at least 90 mol. %, or at least 95 mol. %, or at least 97 mol. %, or at least 98 mol. %, or at least 99 mol. %, based on the total number of moles of recurring units in the PAES copolymer, of:
the recurring units (R_{AO}) of formula (M₁aⁱ) and/or (M′₁aⁱ) and (R_{PAES}) of formula (N₁a) shown below:

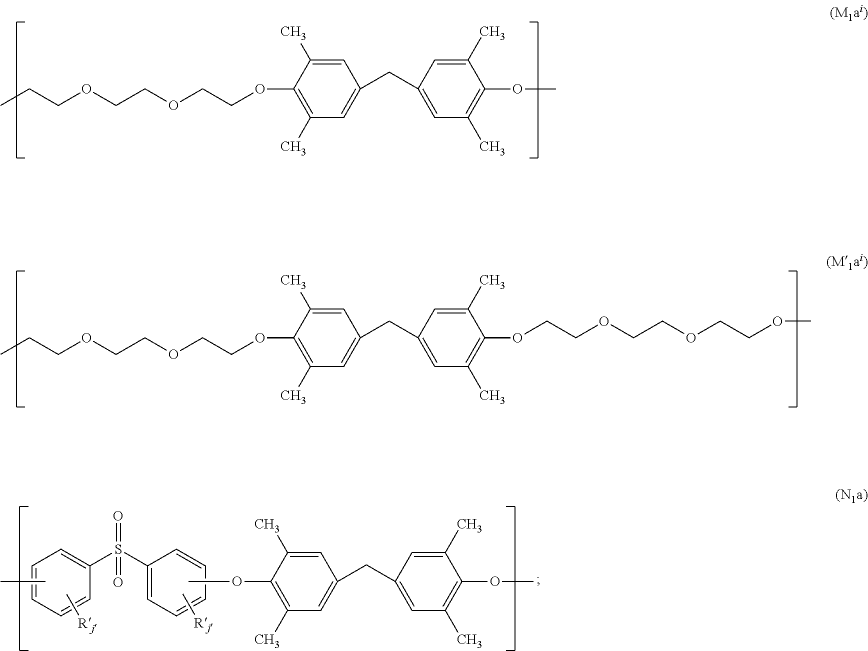

the recurring units (R_{AO}) of formula (M₁aⁱⁱ) and/or (M′₁aⁱⁱ) and (R_{PAES}) of formula (N₁b) shown below:

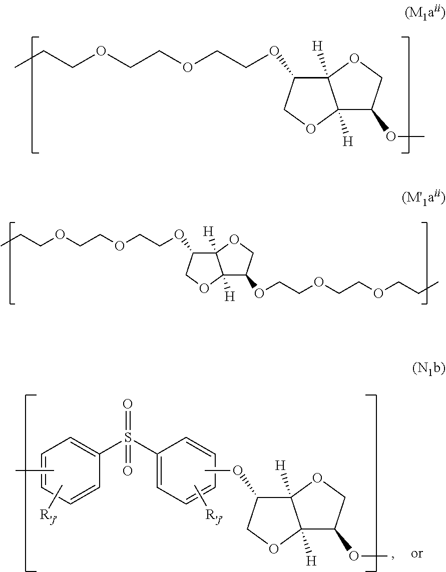

the recurring units (R_{AO}) of formula (M₁aⁱⁱⁱ) and/or (M′₁aⁱⁱⁱ) and (R_{PAES}) of formula (N₁c) shown below:

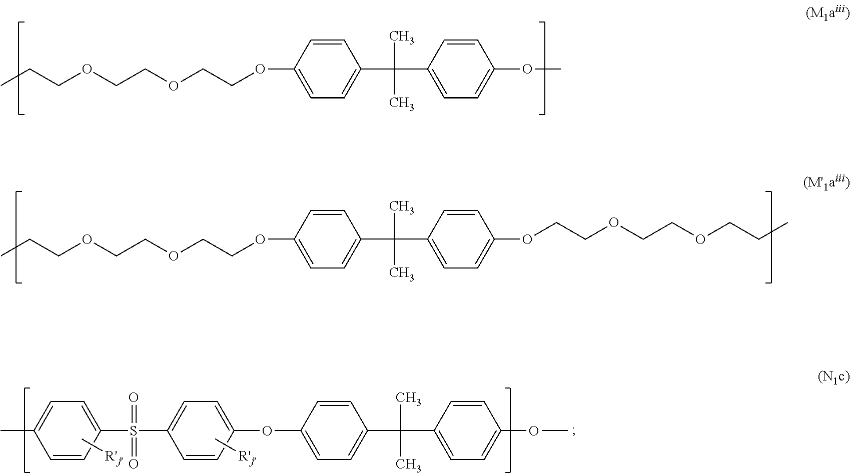

or
the recurring units (R_{AO}) of formula (M₁a^{iv}) and/or (M′₁a^{iv}) and (R_{PAES}) of formula (N₁d) shown below:

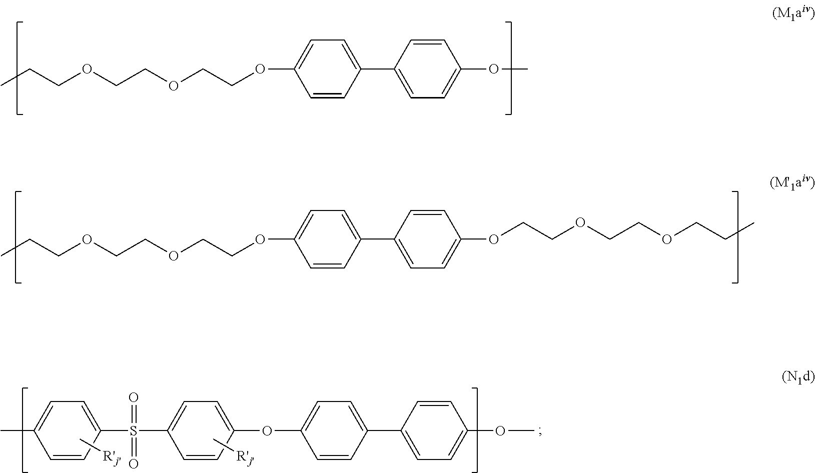

or
the recurring units (R_{AO}) of formula (M₁a^{v}) and/or (M′₁a^{v}) and (R_{PAES}) of formula (N₁e) shown below:

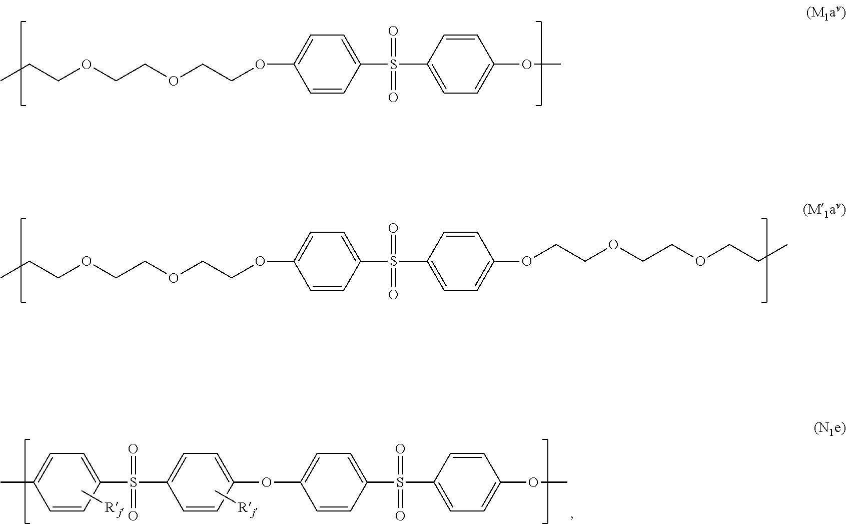

wherein, in formulae (N₁a), (N₁b), (N₁c), (N₁d) and (N₁e), j′=0 or 1 for each R′.

In formulae (N₁a), (N₁b), (N₁c), (N₁d) and (N₁e), when j′=1, R′ is preferably selected from the group consisting of alkali metal sulfonates, alkaline earth metal sulfonates and alkyl sulfonates.

More preferably, the PAES copolymer consists essentially of:
the recurring units (R_{AO}) of formula (M₁aⁱ) and (R_{PAES}) of formula (N₁a); or
the recurring units (R_{AO}) of formula (M₁aⁱⁱ) and (R_{PAES}) of formula (N₁b); or
the recurring units (R_{AO}) of formula (M₁aⁱⁱⁱ) and (R_{PAES}) of formula (N₁c); or
the recurring units (R_{AO}) of formula (M₁a^{iv}) and (R_{PAES}) of formula (N₁d); or
the recurring units (R_{AO}) of formula (M₁a^{v}) and (R_{PAES}) of formula (N₁e),
   wherein j′=0 or 1 for each R′ in formulae (N₁a), (N₁b), (N₁c), (N₁d) and (N₁e).

The PAES copolymer is preferably a random polymer.

The PAES copolymer preferably excludes block copolymers containing at least one poly(oxyalkylene) block and at least one poly(aryletherarylsulfone) block, more preferably excludes diblock AB or triblock ABA copolymers consisting of one or two poly(ethylene oxide) as block A and a poly(aryletherarylsulfone) as block B.

The alkylene oxide (AO) weight content in the PAES copolymer, based on the weight of alkylene oxide present in total copolymer weight, may be at least 1 wt. %, at least 1.2 wt. %, at least 2 wt. %, at least 2.5 wt. %, at least 3 wt. %, and/or at most 22 wt. %, at most 20 wt. %, at most 18 wt. %, at most 15 wt. %, at most 12 wt. %, at most 10 wt. %, at most 8 wt. %, or at most 7 wt. %.

The PAES copolymer has a weight average molecular weight Mw greater than 10,000 kDa, or of at least 15,000 kDa, or of at least 20,000 kDa, or of at least 30,000 kDa, or of at least 35,000 kDa, and optionally up to 150,000 kDa, or up to 120,000 kDa, or up to 100,000 kDa, said Mw being measured by GPC using methylene chloride as mobile phase and using polystyrene standards for calibration.

The PAES copolymer may have a PDI of at least 2.0, at least 2.1, at least 2.2, at least 2.3, at least 2.4, at least 2.5, at least 2.6, at least 2.7, or at least 3, and/or less than 4, at most 3.9, or at most 3.8.

The PAES copolymer preferably has a Tg of at least 95° C., at least 100° C., at least 110° C., at least 120° C., at least 125° C., or at least 130° C. and/or at most 250° C., at most 240° C., at most 220° C., at most 210° C., or at most 200° C., as measured by differential scanning calorimetry (DSC), preferably according to ASTM D3418 or according to the method provided in the Examples.

### Process for Making the PAES Copolymer

The second aspect of the present invention relates to a process for making the PAES copolymer using the condensation of at least one aromatic dihydroxy compound with at least one dihalo aromatic sulfone compound and at least one dihaloalkylene oxide compound.

The process for making the PAES copolymer comprises:

reacting in a reaction mixture comprising a polar aprotic solvent and in the presence of an alkali metal carbonate, a monomer mixture which contains
at least one dihaloalkylene oxide compound [dihalo monomer (AO), hereinafter] comprising a compound selected from the group consisting of compounds of formula (I):

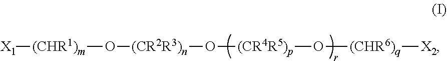

wherein
X₁ and X₂ in formula (I), equal to or different from each other, are independently a halogen atom, preferably Cl, Br or F, more preferably Cl;
each of R¹, R², R³, R⁴, R⁵ and R⁶ in formula (I) is independently H or CH₃;
each of m and q is independently an integer of at least 2 and optionally at most 5, preferably equals to 2, with the proviso that at least one R¹ is H and at least one R⁶ is H;
each of n and p is independently an integer of at least 1 and optionally at most 5, preferably equals to 1 or 2, with the proviso that when n=2, at least one R² or R³ is H; and when p=2, at least one R⁴ or R⁵ is H; and
r in formula (I) is 0, 1, 2 or 3;
at least one dihaloaryl sulfone compound [dihalo monomer (AS), hereinafter] comprising a compound of formula (V):

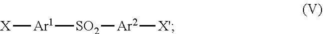

wherein
X and X′, equal to or different from each other in formula (V), are independently a halogen atom, preferably Cl or F, more preferably Cl;
Ar¹ and Ar², equal to or different from each other and at each occurrence in formula (V), are independently aromatic moieties complying with any of the following formulae (H), (H′) and (H″):

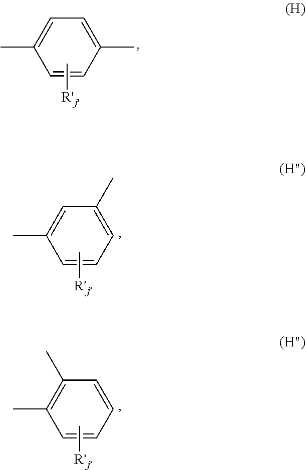

in which each R′, equal to or different form each other, is selected from the group consisting of halogen, alkyl, alkenyl, alkynyl, aryl, ether, thioether, carboxylic acid, ester, amide, imide, alkali or alkaline earth metal sulfonate, alkyl sulfonate, alkali or alkaline earth metal phosphonate, alkyl phosphonate, amine and quaternary ammonium; and
in which each j′, equal to or different from each other, are independently 0, 1, 2, 3 or 4, preferably j′=1 or 0;
at least one dihydroxy compound [dihydroxy monomer (B), hereinafter] comprising a diol selected from the group consisting of:
   tetramethyl bisphenol F,
   at least one 1,4:3,6-dianhydrohexitol selected from the group consisting of isosorbide (1,6-dianhydroisorbitol), isomanide (1, dianhydroiodide), and isodide (1,6-dianhydroiditol), preferably isosorbide,
   at least one alicyclic diol selected from the group consisting of 1,4-cyclohexanedimethanol, 1,3-cyclohexanedimethanol, 1,2-cyclohexane dimethanol, tricyclodecane dimethanol, adamantanediol, pentacyclopentadecane dimethanol, 1,3-cyclobutanediol, and 2,2,4,4-tetramethyl-1,3-cyclobutanediol (“CBDO”), preferably CBDO, and
   aromatic diols of formula (VI):

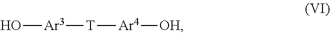

preferably 4,4′-biphenol, Bisphenol A, and/or Bisphenol S, and
any combination thereof,
   in which:
Ar³ and Ar⁴, equal to or different from each other and at each occurrence in formula (VI), are independently aromatic moieties complying with any of the following formulae (J), (J′) and (J″):

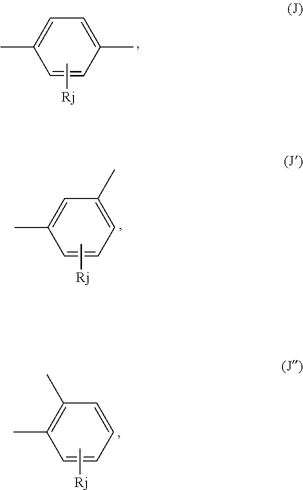

in which each R, equal to or different form each other in formula (VI), is selected from the group consisting of halogen, alkyl, alkenyl, alkynyl, aryl, ether, thioether, carboxylic acid, ester, amide, imide, alkali or alkaline earth metal sulfonate, alkyl sulfonate, alkali or alkaline earth metal phosphonate, alkyl phosphonate, amine and quaternary ammonium; and
in which each j, equal to or different from each other, are independently 0, 1, 2, 3 or 4, preferably j=1 or 0,
T in formula (VI) is selected from the group consisting of a bond, —SO₂—, —C(CH₃)₂—, —C(CF₃)₂—, —C(CCl₃)₂—, —C(═CCl₂)—, —CH₂—, —O—, —C(O)—, —C(CH₃)(CH₂CH₂COOH)—, —S—, and —SO—, preferably selected from a bond, —SO₂—, and/or —C(CH₃)₂—, and
   wherein
the monomer mixture contains at least 4 mol. %, or at least 5 mol. %, or at least 6 mol. %, or at least 8 mol. %, or at least 10 mol. %, and up to 50 mol. %, or at most 30 mol. %, or at most 25 mol. %, of the dihalo monomer (AO), said mol. % being based on the combined numbers of moles of dihalo monomers (AO) and (AS);
the overall amount of halo-groups and hydroxyl-groups of the monomers in the monomer mixture is substantially equimolecular; and
the amount of the alkali metal carbonate used in the reaction mixture, when expressed by the ratio of the equivalents of alkali metal (M) per equivalent of hydroxyl group (OH) in the dihydroxy monomer (B) [eq. (M)/eq. (OH)] is greater than 1, preferably at least 1.05 and optionally up to 2, or up to 1.5, or up to 1.3.

For the purpose of the present invention, the expression “substantially equimolecular” used with reference to the overall amount of halo-groups and hydroxyl-groups of the monomers of the monomer mixture, as above detailed, is to be understood that the molar ratio between the overall amount of hydroxyl groups of the monomer (B) of the monomer mixture and overall amount of halo groups of the monomers (AO) and (AS) of the monomer mixture is from 0.95 to 1.05, or from 0.98 to 1.02, or from 0.99 to 1.01, or from 0.995 to 1.005; good results were obtained with a ratio of 0.995 to 1.000.

In formula (I), m, n and q are preferably 2 and r preferably equals 0.

In formula (I), when r is 1, 2, or 3, then p is preferably 2.

The alkylene oxide moiety in the dihalo monomer (AO) of formula (I), which is represented by:

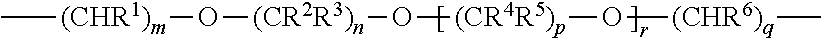

preferably has at least 5 carbon atoms and at most 9 carbon atoms and/or at least 2 oxygen atoms and at most 4 oxygen atoms.

The polymerization reaction mixture preferably excludes any polyalkylene oxide (“PAO”) which does not include halogen end groups, or may comprise less than 1 wt. %, or less than 0.5 wt. %, or less than 0.1 wt. %, of such PAO, such wt. % being based on the total weight of the monomer mixture. A “polyalkylene oxide” is understood to mean those polyalkylene oxides obtained by polymerisation of alkylene oxide such as ethylene oxide, 1,2-propylene oxide. The “polyalkylene oxide” may be generally represented by the following formula: Rₑ—[(CHR_{I})_{y}O]_{z}—H in which R_{I} is H or an alkyl; y may be 1 to 3; z may be from 2 to 500; and the end groups Rₑ may be hydroxy (OH), mesylate, tosylate and/or NH₂. The PAO excluded from the reaction mixture is preferably selected from the group consisting of PAO having two hydroxyl groups, monomethyl PAO, and mesylated PAO. The PAO excluded from the reaction mixture is more preferably selected from the group consisting of polyethylene glycol (PEG) having two hydroxyl groups; polypropylene glycol (PPG) having two hydroxyl groups; monomethyl PEG; monomethyl PPG; mesylated PEG; and mesylated PPG.

The polymerization reaction to prepare the PAES copolymer is preferably carried out in a reaction mixture comprising the monomers (B), (AO) and (AS) and at least one solvent [S]. The solvent [S] is for example a polar aprotic solvent selected from the group consisting of 1,3-dimethyl-2-imidazolidinone (DMI), dimethylsulfoxide (DMSO), dimethylsulfone (DMSO2), diphenylsulfone, diethylsulfoxide, diethylsulfone, diisopropylsulfone, tetrahydrothiophene-1,1-dioxide (commonly called tetramethylene sulfone or sulfolane), N-Methyl-2-pyrrolidone (NMP), N-butylpyrrolidinone (NBP), N-ethylpyrrolidone (NEP), N,N′-dimethylacetamide (DMAc), N,N′-dimethylpropyleneurea (DMPU), dimethylformamide (DMF), tetrahydrothiophene-1-monoxide, and mixtures thereof. The solvent [S] is preferably selected from the group consisting of N-methylpyrrolidone (NMP), N-butylpyrrolidone (NBP), N-ethyl-2-pyrrolidone, N,N-dimethylformamide (DMF), N,N dimethylacetamide (DMAc), 1,3-dimethyl-2-imidazolidinone, tetrahydrofuran (THF), dimethyl sulfoxide (DMSO), sulfolane and mixtures thereof. The polymerization reaction to prepare the PAES copolymer is more preferably carried out in sulfolane, DMI, DMSO, DMAc or NMP.

The polymerization reaction (polycondensation) to prepare the PAES copolymer may be carried out in the presence of an alkali metal carbonate as a base. The base acts to deprotonate the dihydroxy monomer (B) during the polycondensation. The alkali metal carbonate preferably comprises potassium carbonate and/or sodium carbonate, preferably comprises potassium carbonate, more preferably consists of potassium carbonate.

The amount of the alkali metal carbonate used in the reaction mixture, when expressed by the ratio of the equivalents of alkali metal (Me) per equivalent of hydroxyl group (OH) in the monomer (B) [eq. (Me)/eq. (OH)] is greater than 1, preferably at least 1.05 and optionally up to 2, or up to 1.5, or up to 1.3.

The polymerization reaction to prepare the PAES copolymer may be carried out with a monomers molar ratio (B)/[(AO)+(AS)] from 0.9 to 1.1, for example from 0.92 to 1.08.

The overall amount of halo-groups and hydroxyl-groups of the monomers in the monomer mixture is preferably substantially equimolecular, such as molar ratios of hydroxyl-groups to halo-groups from 0.95 to 1.05, or from 0.98 to 1.02, or from 0.99 to 1.01, or from 0.995 to 1.005.

For making the PAES copolymer of the invention, the dihydroxy monomer (B) comprises, based on the total weight of the monomer (B) in the reaction mixture, at least 50 wt. %, at least 60 wt. %, at least 70 wt. %, at least 80 wt. %, at least 90 wt. %, at least 95 wt. %, or at least 99 wt. %, of a diol selected from the group consisting of: tetramethyl bisphenol F; 1,4:3,6-dianhydrohexitols chosen from isosorbide, isomanide and/or isodide; alicyclic diols chosen from 1,4-cyclohexanedimethanol, 1,3-cyclohexanedimethanol, 1,2-cyclohexane dimethanol, tricyclodecane dimethanol, adamantanediol, pentacyclopentadecane dimethanol, 1,3-cyclobutanediol, and/or any isomers of 2,2,4,4-tetramethyl-1,3-cyclobutanediol (CBDO); and aromatic diols of the formula (VI). The dihydroxy monomer (B) may preferably consist essentially at least one diol selected from the group consisting of: biphenol, bisphenol A, bisphenol S, TMBPF, isosorbide (1,6-dianhydroisorbitol), cis- and trans-CBDO, and any combination thereof. The dihydroxy monomer (B) may more preferably consist essentially at least one aromatic diol selected from the group consisting of: TMBBF, biphenol, bisphenol A, bisphenol S, and any combination thereof.

The monomer mixture preferably comprises at least one dihydroxy (B) monomer selected from the group consisting of:

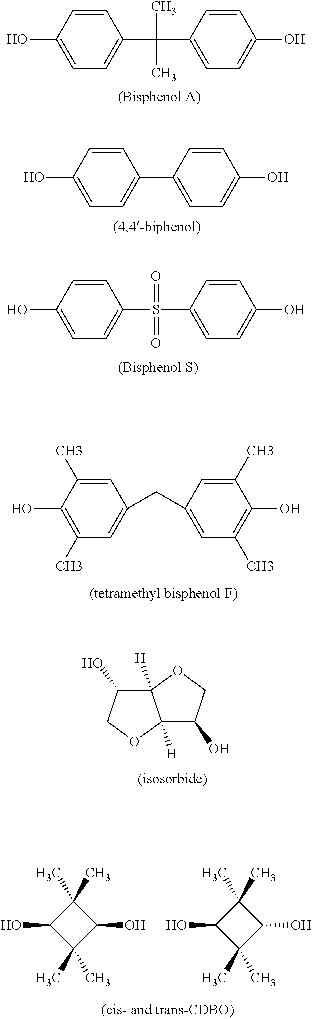

and any combination thereof.

The monomer mixture may comprise tetramethyl bisphenol F as a dihydroxy (B) monomer, and optionally at least one other dihydroxy (B) monomer selected from the group consisting of Bisphenol A, Bisphenol S, 4,4′-biphenol, isosorbide, and any combination thereof.

The monomer mixture may comprise tetramethyl bisphenol F as the sole dihydroxy (B) monomer.

The monomer mixture may comprise Bisphenol A, Bisphenol S, or 4,4′-biphenol, as the sole dihydroxy (B) monomer.

The monomer mixture may comprise isosorbide as a dihydroxy (B) monomer, and optionally at least another dihydroxy (B) monomer selected from the group consisting of Bisphenol A, Bisphenol S, 4,4′-biphenol, tetramethyl bisphenol F and any combination thereof.

For making the PAES copolymer of the present invention, the dihalo monomer (AO) preferably comprises at least one compound having the formula (I), in which X₁ and X₂ are both Cl.

The dihalo monomer (AO) more preferably comprises, or consists of, at least one compound represented by any of the formula (Ia) to (Ii):

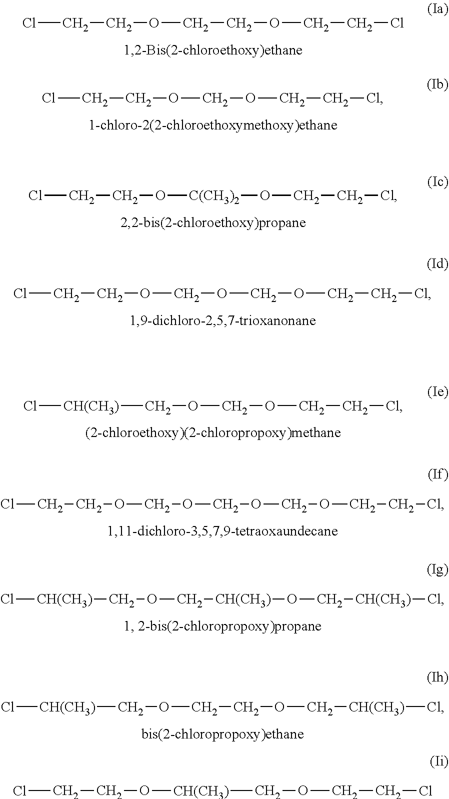

2,2-bis(2-chloroethoxy)propane.

The dihalo monomer (AO) yet more preferably comprises, or consists of, at least one compound represented by any of the formulae (Ia), (Ib), (Ig), (Ih) and/or (Ii), yet more preferably comprises, or consists of, at least one compound represented by any of the formulae (Ia), (Ig), (Ih) and/or (Ii).

The dihalo monomer (AO) comprises, based on the total weight of the dihydroxy monomer (AO) in the reaction mixture, at least 50 wt. %, at least 60 wt. %, at least 70 wt. %, at least 80 wt. %, at least 90 wt. %, at least 95 wt. %, or at least 99 wt. %, of at least one compound having a formula selected from any of the formulae (I), (Ia) to (Ii). The dihalo monomer (AO) may more preferably consist essentially of the compound having a formula selected from any of the formulae (I), (Ia) to (Ii), yet more preferably consist essentially of at least one compound having a formula represented by any of the formulae (Ia), (Ib), (Ig), (Ih) and/or (Ii). The dihalo monomer (AO) most preferably consists essentially of the compound having the formula (Ia).

For making the PAES copolymer of the present invention, the dihalo monomer (AS) comprises, based on the total weight of the monomer (AS), at least 50 wt. %, at least 60 wt. %, at least 70 wt. %, at least 80 wt. %, at least 90 wt. %, at least 95 wt. %, or at least 99 wt. %, of at least one dihalodiphenylsulfone of the formula (V). The dihalo monomer (AS) may preferably consist essentially of at least one 4,4-dihalodiphenylsulfone selected from the group consisting of: 4,4′-dichlorodiphenyl sulfone (DCDPS), disulfonated 4,4′-dichlorodiphenyl sulfone (sDCDPS), 4,4′ difluorodiphenyl sulfone (DFDPS), disulfonated 4,4′ difluorodiphenyl sulfone (sDFDPS), and any combination thereof. The dihalo monomer (AS) more preferably consists essentially of DCDPS and/or disodium bis(4-chloro-3-sulfophenyl)sulfone (disodium sulfonated DCDPS) as shown below:

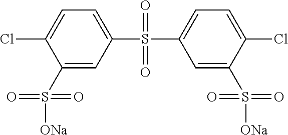

The dihalo monomer (AS) may comprise two or more 4,4-dihalodiphenylsulfones. In particular, the monomer (AS) may comprise at least 80 wt. %, at least 90 wt. %, at least 95 wt. %, or at least 99 wt. %, based on the total weight of the monomer (AS), of a combination of 4,4-dihalodiphenylsulfone and sulfonated dihalodiphenylsulfone of formula (V), in which at least one R₁ in the sulfonated 4,4-dihalodiphenylsulfone of the formula (V) is selected from the group consisting of alkali or alkaline earth metal sulfonates and alkyl sulfonates, and its corresponding j′ is equal to 1.

The monomer mixture preferably comprises 4,4′-dichlorodiphenylsulfone (DCDPS) and/or any sulfonated derivatives of DCDPS as at least one dihalo (AS) monomer.

To prepare the PAES copolymer of the present invention, the monomers (B), (AS) and (AO) of the reaction mixture are generally reacted concurrently, meaning that the reaction is conducted in a single synthesis stage, also called ‘one-pot’ synthesis. The deprotonation of monomers (B) and the condensation reaction between the monomers (AO)+(AS) and the monomer (B) takes place in a single reaction stage without isolation of intermediate products.

The polymerisation may be carried out in a reaction mixture containing the polar aprotic solvent [S] and further comprising a co-solvent which forms an azeotrope with water. The co-solvent which forms an azeotrope with water includes aromatic hydrocarbons such as benzene, toluene, xylene, ethylbenzene, chlorobenzene and the like. The co-solvent is preferably toluene or chlorobenzene, more preferably toluene. The azeotrope forming co-solvent and the polar aprotic solvent [S] are used typically in a weight ratio of from about 1:100 to about 1:1, or from about 1:50 to about 1:1, or from about 1:20 to about 1:1, or from about 1:10 to about 1:1. Water is continuously removed from the reaction mass as an azeotrope with the azeotrope forming co-solvent so that substantially anhydrous conditions are maintained during the polymerization. The azeotrope-forming co-solvent, for example, chlorobenzene or toluene, is removed from the reaction mixture, typically by distillation, after the water formed in the reaction, leaving the PAES copolymer dissolved in the polar aprotic solvent [S].

In preferred embodiments of the process for making the PAES copolymer of the present invention, the reaction mixture preferably comprises:
a dihalo (AO) monomer represented by formula (Ia);
4,4′-dichlorodiphenylsulfone (DCDPS) and/or any sulfonated derivatives of DCDPS as at least one dihalo (AS) monomer or the sole dihalo (AS) monomer;
at least one dihydroxy (B) selected from TMBPF, isosorbide, Bisphenol A, biphenol, Bisphenol S, or any combination thereof,
potassium carbonate and/or sodium carbonate, preferably potassium carbonate, as the alkali metal carbonate,
a solvent selected from NMP, DMAc, sulfolane, DMSO, DMI or combinations thereof;
optionally a co-solvent which forms an azeotrope with water, preferably selected from benzene, toluene, xylene, ethylbenzene, chlorobenzene, or any combination thereof, more preferably toluene and/or chlorobenzene,
   wherein
the mol % content of the dihalo (AO) monomer of formula (Ia) is from 2 to 25 mol. % based on the total number of moles of monomers (AO), (AS) and (B) in the reaction mixture;
the overall amount of halo-groups and hydroxyl-groups of the monomers in the monomer mixture is substantially equimolecular; and
the amount of the potassium carbonate and/or sodium carbonate used in the reaction mixture, when expressed by the ratio of the equivalents of alkali metal (Me) per equivalent of hydroxyl group (OH) in the monomer (B) [eq. (Me)/eq. (OH)] is at least 1.05 and up to 1.5, or up to 1.3.

The temperature of the reaction mixture to prepare the PAES copolymer is kept at about 150° C. to about 250° C., preferably from about 165° C. to about 250° C., for about one to 24 hours or from 4 to 16 hours. Preferred temperature of the reaction mixture may be from about 180° C. to about 220° C. when NMP and/or sulfolane is used as solvent [S]. Preferred temperature of the reaction mixture may be from about 160° C. to about 175° C. when DMAc is used as solvent [S].

The inorganic constituents, for example sodium chloride or potassium chloride or excess of base, can be removed, before or after isolation (separation) of the PAES copolymer, by suitable methods such as dissolving and filtering, screening or extracting.

The amount of copolymer at the end of the condensation is at least 25 wt. %, or at least 30 wt. %, and/or at most 50 wt. %, at most 45 wt. %, or at most 40 wt. %, based on the total weight of the PAES copolymer and the polar aprotic solvent [S].

At the end of the polymerization reaction, the PAES copolymer is separated from the other components (salts, base, . . . ) to obtain a solution. Filtration can for example be used to separate the PAES copolymer from the other components.

The optionally-filtered solution containing the PAES copolymer can then be used ‘as such’ to make an article which is described later.

Alternatively, the PAES copolymer may be recovered in solid form from the solvent [S] (used during polycondensation), for example by coagulation or devolatilization of the solvent [S].

The PAES copolymer in solid form may be dissolved in a solvent [Sp] (same or different than [S]) to make an article.

The process for making the PAES copolymer of the present invention according to the present invention may further comprise at least one of the following steps, between the polymerization step and the PAES copolymer separation step:
i. cooling: decreasing the temperature of the reaction mixture;
ii. quenching: adding a solvent (S_{q}), which may be the same or different than the polar aprotic solvent (S), to quench the reaction mixture, generally to stop the reaction and dilute the reaction mixture to reduce its viscosity; and/or
iii. end-capping: adding an end-capping agent to convert hydroxyl end groups of the formed PAES copolymer to less reactive end groups.

Step (i): Cooling may be affected by stopping the heating of the reaction mixture. Cooling may be effected by adding, directly into the reaction mixture, a further amount of the polar aprotic solvent (S) or another polar aprotic solvent which is at a temperature of at least 50° C. less, at least 60° C. less, or at least 70° C. less, than the reaction mixture temperature. The solvent added to the reaction mixture for cooling is preferably at ambient temperature. The solvent added for cooling is preferably selected from the group consisting of sulfolane, DMSO, DMAc, DMI, NMP, and any combination thereof. Alternatively, cooling may be affected by passing a cooling fluid (without being mixed with the reaction mixture) inside cooling tubes or using a cooling jacket for the reactor vessel inside which the polymerization takes place.

Step (ii): Quenching may be carried out at the end of the reaction to decrease the polymer content of the reaction mixture to a value of 20 wt. % or less based on the total weight of the quenched reaction medium. The solvent (S_{q}) added for quenching is preferably the same as the polar aprotic solvent (S) used during the reaction, but not necessarily. The solvent (S_{q}) is preferably selected from the group consisting of sulfolane, DMSO, DMAc, DMI, NMP, and any combination thereof. After quenching, the polymer content of the quenched reaction mixture is preferably from 5 to 20 wt. %, more preferably from 8 to 18 wt. %, most preferably from 10 to 16 wt. %, based on the total weight of the quenched reaction mixture.

The cooling and quenching steps (i) and (ii) may be carried out simultaneously by using a solvent (S_{q}) having a cooler temperature than the reaction temperature of the reaction mixture at end of the polymerisation.

Step (iii): The end-capping (also called termination) preferably converts reactive hydroxyl end groups of the formed PAES copolymer to less reactive end groups. The end-capping agent is preferably methyl chloride (“MeCl”). The methyl chloride gas may be passed through the reaction mixture. The end-capping step (iii) may take place before or after the cooling of the reaction mixture. As such the end-capping step (iii) may be carried out at the end of the polycondensation reaction, either at reaction temperature or at a lower temperature than the reaction temperature. If one desires to obtain a final PAES copolymer product with reactive (—OH) end groups, the end-capping step (iii) is preferably omitted in the process of the present invention.

### A PAES Copolymer Obtained by the Process

A further aspect of the present invention is directed to a PAES copolymer made by the process according to the present invention.

The description related to the PAES copolymer including its preferred embodiments described previously is equally applicable for the PAES copolymer obtained by such a process.

### Use of the PAES Copolymer

Another aspect of the present invention provides the use of the PAES copolymer of the present invention for making an article (or a part thereof) as described herein. This aspect also relates to a method for making an article (or a part thereof) comprising the PAES copolymer of the present invention.

The article may be made from a polymer solution or polymer melt comprising the PAES copolymer of the present invention.

The PAES copolymer according to the invention may be used to make a non-porous article, such as a dense film. Such a dense film may be a thick or thin film. Such use may include polymer solution casting or a polymer melt processing method such as injection molding or extrusion. In such instances, the PAES copolymer of the present invention may be the sole polymer in the non-porous article; alternatively, the non-porous article may further comprise at least one other polymer.

The PAES copolymer according to the invention may be used to make a porous article, such as porous film, hollow fiber, hollow tube or porous membrane, using a phase inversion technique selected from nonsolvent induced phase separation or thermally induced phase separation. Such use may include casting or spinning a polymer dope solution comprising the PAES copolymer, a solvent, optionally a co-solvent and optionally at least one pore forming agent, such as polyvinylpyrrolidone (PVP) and polyethylene glycol (PEG), into the porous article, which is then cooled or contacted with a non-solvent. In such instances, the PAES copolymer may be the sole polymer in the dope solution; alternatively, the dope solution may further comprise at least one other polymer, preferably being selected from the group consisting of PSU, sulfonated PSU, PPSU, sulfonated PPSU, PES, sulfonated PES, polyvinylidene fluoride (PVDF), and any combination thereof.

When at least one other polymer is used in the making of a non-porous or porous article, such other polymer is preferably selected from the group consisting of PSU, sulfonated PSU, PPSU, sulfonated PPSU, PES, sulfonated PES, PVDF, and any combination thereof.

### Article Comprising the PAES Copolymer

Another aspect of the present invention provides an article (preferably a shaped article) comprising, or made from, the PAES copolymer according to the present invention.

The article comprising the PAES copolymer may be porous or non-porous.

The article comprising the PAES copolymer may preferably be a porous article such as porous film, hollow fiber, hollow tube, porous membrane, or a part thereof (such as a (internal) porous layer or porous coating).

As used herein, a “coating” according to the present invention is generally understood to be a layer fixed to the surface of a substrate, especially adhering thereon. A coating may be a thin or thick layer, and/or may be a plurality of layers. The substrate used may be made from any suitable known materials, such as metals, insulating materials, semiconducting materials, crystalline or amorphous polymeric materials, textile fabrics or films.

As used herein, a “fiber” according to the present invention is generally understood to be a flexible structure whose width is thin compared to its length. Fibers preferably have a thickness of 0.5 to 100 microns.

As used herein, a “membrane” according to the present invention is a separating article. The membrane may be non-porous, partly porous, selectively permeable, such as a membrane which is pervious in one direction, or may be preferably porous.

The PAES copolymer may be the sole polymer in the article.

The PAES copolymer may form all, or substantially all, of the article.

Alternatively, the article comprising the PAES copolymer may further comprise at least one other polymer distinct from the PAES copolymer. In such instance, the article may further comprise at least one other polymer selected from the group consisting of another aromatic sulfone polymer which may be optionally sulfonated, such as polysulfone (PSU), sulfonated polysulfone (sPSU), polyethersulfone (PES), sulfonated polyethersulfone (sPES), poly(biphenyl ether sulfone) (PPSU), sulfonated poly(biphenyl ether sulfone) (sPPSU), a polyvinylidene fluoride (PVDF), a polyphenylene sulfide (PPS), a poly(aryl ether ketone) (PAEK) such as a poly(ether ether ketone) (PEEK), a poly(ether ketone ketone) (PEKK), a poly(ether ketone) (PEK) or a copolymer of PEEK and poly(diphenyl ether ketone) (PEEK-PEDEK copolymer), a polylactide (PLA), a polyetherimide (PEI), a polycarbonate (PC), a polyphenylene oxide (PPO), polyvinylpyrrolidone (PVP) and/or polyalkylene oxide (PAO) such as PEG. The article may further comprise at least one other polymer preferably selected from the group consisting of PSU, sPSU, PES, sPES, PPSU, sPPSU, PVDF, and combination thereof.

When the article comprises at least another polymer, the PAES copolymer may be in an amount ranging from 1 to 99 wt. %, for example from 2 to 98 wt. %, from 3 to 97 wt. % or from 4 to 96 wt. %, based on the total weight of polymers present in the article. The weight fraction of the PAES copolymer based on the combined weights of PAES copolymer and the other polymer(s) in the article is preferably at least 5 wt. %, at least 6 wt. %, at least 7 wt. %, at least 8 wt. %, at least 9 wt. %, or at least 10 wt. %, and/or up to 50 wt. %, up to 45 wt. %, up to 40 wt. %, up to 35 wt. %, up to 30 wt. %, up to 25 wt. %, up to 20 wt. % up to 17 wt. %, or up to 15 wt. %. In preferred instances, the weight fraction of the PAES copolymer in the article may be from 5 to 25 wt. %, or from 7 to 20 wt. %, or from 8 to 17 wt. %, or from 10 to 15 wt. %, based on the combined weights of PAES copolymer and the other polymer(s).

When the article is porous such as a porous film, hollow fiber, hollow tube, porous membrane, or a part thereof, the article may comprise the PAES copolymer as a polymeric additive to at least one bulk polymer, preferably selected from the group consisting of PSU, sulfonated PSU, PPSU, sulfonated PPSU, PES, sulfonated PES, PVDF, and any combination thereof. In preferred instances, the PAES copolymer is a polymeric additive to a bulk (other) polymer, and the weight fraction of the PAES copolymer in the article may be from 5 wt. % to 25 wt. %, or from 7 wt. % to 20 wt. %, or from 8 wt. % to 17 wt. %, or from 10 wt. % to 15 wt. %, based on the combined weights of PAES copolymer and the bulk (other) polymer.

The PAES copolymer of the present invention used as a polymeric additive in a hydrophobic bulk polymer improves the wettability of such a hydrophobic bulk polymer such as PSU, PPSU or PES that are typically used in forming porous membranes for hemodialysis and for water filtration such as ultrafiltration and microfiltration applications.

The PAES copolymer of the present invention when added as a polymeric additive in a high-Tg bulk polymer may also improve the flexibility of the resulting blended polymeric material. The high-Tg bulk polymer, preferably having a Tg 180° C., may be a sulfone polymer selected from polysulfone (PSU), polyphenylsulfone (PPSU), polyethersulfone (PES), any copolymers thereof, or any blends thereof, such sulfone polymers being typically used in forming porous articles such as membranes (e.g., hollow fiber membranes) suitable for hemodialysis or water filtration such as ultrafiltration, nanofiltration and microfiltration applications. Indeed, because the PAES copolymer of the present invention generally has a lower Tg than the Tg of PSU, PPSU or PES, using the PAES copolymer of the present invention as an additive in a PSU, PPSU or PES bulk polymer provides a way to increase the flexibility of the resulting blended polymeric material. That is to say, the Tg of the polymeric blend is decreased compared to that of the bulk polymer and its ductibility upon bending is improved (less brittle material) and the modulus is decreased (less stiff) compared to the bulk polymer.

In some embodiment of the invention when the article comprises at least another polyarylethersulfone polymer and when the PAES copolymer of the invention has recurring units (R_{PAES}) in which -E- is represented by formula (E7): —Ar³-T-Ar⁴— as described above, the sulfone recurring units of this other PAES polymer are also represented by -E- of formula (E7) with a -T- linking group being the same as the -T- in the recurring units (R_{PAES}) of the PAES copolymer. For example, when the recurring units (R_{PAES}) of the PAES copolymer of the invention is of the formula (N₁e) in which -T- is —SO₂— and each of the R′ groups is unsubstituted (j′=0) or sulfonated (i.e., j′=1 and R′ is selected from the group consisting of alkali metal sulfonates, alkaline earth metal sulfonates and alkyl sulfonates), then the other polyarylethersulfone polymer used in the article is preferably a polyethersulfone (PES) and/or a sulfonated PES. Alternatively, when the recurring units (R_{PAES}) of the PAES copolymer of the invention is of the formula (N₁e) in which -T- is —C(CH₃)₂— and each of the R′ groups is unsubstituted (j′=0) or sulfonated (i.e., j′=1 and R′ is selected from the group consisting of alkali metal sulfonates, alkaline earth metal sulfonates and alkyl sulfonates), then the other polyarylethersulfone polymer used in the article is preferably a polyethersulfone (PSU) and/or a sulfonated PSU.

In alternate embodiment of the invention when the article comprises at least another polyarylether sulfone polymer and when the PAES copolymer of the invention has recurring units (R_{PAES}) in which -E- is represented by any of the formulae (E1) to (E6) as described above, then the main sulfone recurring units of the other polyarylethersulfone polymer is preferably represented by -E- of formula (E7) in which -T- is selected from a bond, —SO₂— or —C(CH₃)₂—.

The article may further comprise at least one non-polymeric ingredient such as a solvent, a filler, a lubricant, a mold release, an antistatic agent, a flame retardant, an anti-fogging agent, a matting agent, a pigment, a dye, a UV light stabilizer, a heat stabilizer, and/or an optical brightener. Alternatively, the article may exclude one or more non-polymeric ingredients selected from fillers, lubricants, mold release agents, antistatic agents, flame retardants, anti-fogging agents, matting agents, pigments, dyes, UV light stabilizers, heat stabilizers, and/or optical brighteners.

The PAES copolymer of the invention can be included in at least a portion of a surface of the article such surface being intended to come in contact with an aqueous solution, water, a biological fluid such as blood, plasma, or serum, or a food product such as fruit juice, milk, beer.

The PAES copolymer of the invention may be incorporated into an article having a polymeric layer. A person of ordinary skill in the art will know which layer is intended to contact a fluid such as an aqueous medium, such as water, an aqueous solution (e.g., alkaline), a biological fluid (e.g., blood, plasma or serum) and/or food product (e.g., fruit juice, milk, beer) based upon the article's intended application setting. The polymeric layer may be an external or internal layer of the article. At least a portion of that layer may come into direct contact with the fluid in its intended application setting. For example, a medical device may have an external layer intended to come into direct contact with a biological fluid. A thin film composite device like a reverse-osmosis membrane or nanofiltration membrane may have a layer intended to come into direct contact with an aqueous medium or water. In particular, the article can comprise a thin selective layer disposed on an underlying layer or porous substrate. The thin selective layer may comprise, or be made from, the PAES copolymer, while the underlying layer or porous substrate has a composition which excludes the PAES copolymer. Or the underlying layer or porous substrate may comprise, or be made from, the PAES copolymer, while the thin selective layer may has a composition which excludes the PAES copolymer. Alternatively, both of the thin selective layer and the underlying layer or porous substrate contain the PAES copolymer.

A film, tube, coating or layer comprising the PAES copolymer of the invention may have an average thickness of from about 25 μm to about 1 mm.

A porous membrane may be a microporous membrane which can be characterized by its average pore diameter and porosity, i.e., the fraction of the total membrane that is porous

The porous membrane may have a gravimetric porosity (%) of 20 to 90% and comprises pores, wherein at least 90% by volume of the said pores has an average pore diameter of less than 5 μm. Gravimetric porosity of the porous membrane is defined as the volume of the pores divided by the total volume of the membrane.

From an architectural perspective, porous membranes comprising the PAES copolymer may be provided under the form of flat structures (e.g. having a plurality of films or sheets), corrugated structures (such as corrugated sheets), tubular structures (e.g. having a plurality of tubes), or hollow fibers. Tubular porous membranes are classified based on their dimensions in tubular membranes having a diameter greater than 3 mm; capillary membranes, having a diameter comprised between 0.5 mm and 3 mm; and hollow fibers having a diameter of less than 0.5 mm. Capillary membranes are otherwise referred to as hollow fibers. Hollow fibers are particularly advantageous in applications where compact modules with high surface areas are required.

As per the pore size is concerned, full range of membranes (non-porous and porous, including for microfiltration, ultrafiltration, nanofiltration, ion-exchange, and reverse osmosis) can be advantageously manufactured with the PAES copolymer; the pore distribution can be isotropic or anisotropic.

Membranes having a uniform structure throughout their thickness are generally known as symmetrical membranes; membranes having pores which are not homogeneously distributed throughout their thickness are generally known as asymmetric membranes. Asymmetric membranes are characterized by a thin selective layer (0.1-1 μm thick) and a highly porous thick layer (100-200 μm thick) which acts as a support and has little effect on the separation characteristics of the membrane. As an example, the asymmetric membrane may comprise a thin selective layer comprising, or made from, the PAES copolymer, disposed on an underlying layer or substrate having a composition distinct from the PAES copolymer. Alternatively, the asymmetric membrane may comprise a support layer comprising, or made from, the PAES copolymer, on top of which is disposed a thin selective layer having a composition excluding the PAES copolymer.

### Polymer Solution for Preparing an Article (e.g., Membrane, Fiber or Film)

Another aspect of the present invention is directed to a polymer solution for preparing an article such as membrane, fiber or film, which comprises the PAES copolymer according to the invention in a solvent [solvent (S_{P})].

The solvent (S_{P}) in polymer solution may be selected from the list of solvent provided for the polar aprotic solvent [S] described earlier in relation to the process for making the PAES copolymer. Preferably the solvent (S_{P}) in polymer solution may be N,N′-dimethylacetamide (DMAc), sulfolane, DMSO, NMP, or any combination thereof, such solvent (Sp) particularly suitable for making articles, such as fibers, membranes or films.

Exemplary solvents (S_{P}) which may be used, alone or in combination, in polymer solution are described in patent applications in US2019/054429A1 (Solvay Specialty Polymers Italy), in particular solvents described in paragraphs [0057]-[0129], and WO 2019/048652 (Solvay Specialty Polymers USA), incorporated herein by reference.

The concentration of the solvent (S_{P}) in polymer solution may be at least 20 wt. %, at least 30 wt. %, or at least 40 wt. %, based on the total polymer solution weight and/or is at most 80 wt. %; at most 70 wt. %; or at most 60 wt. %, based on the total polymer solution weight.

The polymer solution may further comprise at least one other polymer distinct from the PAES copolymer. The other polymer distinct from the PAES copolymer may be selected from the group consisting of PSU, sPSU, PES, sPES, PPSU, sPPSU, PVDF, PPS, a PAEK polymer such as PEEK, PEKK, PEK or a copolymer of PEEK and PEEK-PEDEK, PLA, PEI, PC, PPO, PVP and/or PEO; preferably selected from the group consisting of PSU, sPSU, PES, sPES, PPSU, sPPSU, PVDF, and combination thereof.

The overall concentration of the PAES copolymer and optional other polymer(s) in the polymer solution may be at least 8 wt. %, or preferably at least 10 wt. %, based on the total polymer solution weight and/or is at most 70 wt. %; or at most 60 wt. %; or at most 50 wt. %; or at most 40 wt. %; or at most 30 wt. %, based on the total polymer solution weight. Concentrations of all polymers in the polymer solution ranging between 10 wt. % and 30 wt. %, and more preferably between 15 wt. % and 30 wt. %, based on the total polymer solution weight are particularly advantageous.

The polymer solution may include a pore forming agent such as PVP and/or a PEG having a formula weight of at least 200.

Alternatively, the polymer solution may exclude pore forming agent, such as may exclude a PVP and/or a PEG having a formula weight of at least 200.

The polymer solution may contain additional components, such as nucleating agents, fillers and the like. Alternatively, the polymer solution may exclude additional components, such as nucleating agents, fillers and the like.

### Method for Making the Article (Fiber, Film, Membrane or Part Thereof)

An article (such as fiber, film, membrane, or part thereof such as a layer or coating) according to the present invention can be made using any of the conventionally known preparation methods, such as non-limiting examples, by a polymer solution casting method, solution polymer spinning method or polymer melt processing method such as extrusion casting. Different shaping techniques can be used depending on the final form of the article to be manufactured.

This method may comprise casting or spinning a polymer solution (sometimes referred to as “PAES copolymer dope solution”) into a pre-formed article (such as film, fiber, membrane, coating, or layer) which is then cooled and/or contacted with a non-solvent. The polymer dope solution comprises the PAES copolymer of the present invention, the solvent (S_{P}) for the PAES copolymer, and optionally at least a pore forming agent. The pore forming agent may be a PVP and/or a PEG having a formula weight of at least 200.

The PAES copolymer may be the sole polymer in the polymer solution; or the polymer solution further comprises at least one other polymer, preferably being selected from the group consisting of PSU, sulfonated PSU, PPSU, sulfonated PPSU, PES, sulfonated PES, PDVF, and any combination thereof. The solvent (S_{P}) may be selected from the list of solvents provided for solvent [S]. The pore forming agent may be a PVP or a PEG having a formula weight of at least 200.

A porous fiber, film, membrane, or part thereof (such as a layer or coating) according to the present invention may be prepared using a phase inversion technique selected from non-solvent induced phase separation and/or thermally induced phase separation.

When the final article is a flat film, the polymer solution may be casted as a film over a flat supporting substrate, typically a plate, a belt or a fabric, or a microporous supporting membrane, typically by means of a casting knife, a draw-down bar or a slot die.

Alternatively, a polymer solution may be spinned in the form of a tubular film. The tubular film may be manufactured using a spinneret, this technique being otherwise generally referred to as “spinning method”. Hollow fibers and capillary membranes may be manufactured according to the spinning method. The term “spinneret” is hereby understood to mean an annular nozzle comprising at least two concentric capillaries: a first outer capillary for the passage of the polymer solution and a second inner (generally referred to as “lumen”) for the passage of a supporting fluid, also referred to as “bore fluid”.

For the non-solvent induced phase separation, the pre-shaped article is contacted with a non-solvent medium (medium [NS]) thereby providing a porous article. Such step of contacting with a medium [NS] is generally effective for precipitating and coagulating the PAES copolymer constituting the pre-shaped article into a porous article. The PAES copolymer may be precipitated in said medium [NS] by immersion in a coagulation bath containing non-solvent medium [NS]. Alternatively (or usually before immersing in a coagulation bath), contacting the pre-shaped article with medium [NS] may be accomplished by exposing it to a gaseous phase comprising vapors of such medium [NS].

For the purpose of the present invention, the term “non-solvent” [NS] is intended to mean a medium consisting of one or more liquid substances incapable of dissolving the PAES copolymer, and which advantageously promotes the coagulation/precipitation of the PAES copolymer from the polymer solution. The medium (NS) typically comprises water and/or at least one alcohol or polyalcohol, preferably aliphatic alcohols having a short chain, for example from 1 to 6 carbon atoms, more preferably methanol, ethanol, isopropanol and/or ethylene glycol.

For a thermally induced phase separation, coagulation/precipitation of the PAES copolymer may be promoted by cooling. In this case, the cooling of the pre-shaped article may be typically carried out using any conventional techniques. Generally, when the coagulation/precipitation is thermally induced, the solvent (Sp) in the polymer solution is advantageously a “latent” solvent (solvent (LT)), i.e. a solvent which behaves as an active solvent towards PAES copolymer only when heated above a certain temperature, and which is not able to solubilize the PAES copolymer below such temperature. When the polymer solution comprises a latent solvent, the pre-shaping step (e.g., casting) for the making of the article is generally carried out at a temperature high enough to maintain the polymer solution as a homogeneous solution. Cooling may be achieved by contacting the pre-shaped article with a cooling fluid, which may be a gaseous fluid (i.e. cooled air or cooled modified atmosphere) or may be a liquid fluid. In this latter case, it is usual to make use of non-solvent medium [NS] as above detailed, so that the techniques of non-solvent-induced and thermally-induced precipitation may occur simultaneously. It is nevertheless generally understood that even in circumstances where the PAES copolymer precipitation is induced thermally, a further step of non-solvent-induced precipitation, that is to say, contacting with non-solvent medium [NS], is carried out, e.g. for finalizing the copolymer precipitation and facilitating removal of the solvent(s).

In cases where the polymer solution comprises both solvent (Sp) and non-solvent for the copolymer, at least partially selective evaporation of the solvent (Sp) may be used for promoting coagulation/precipitation of the copolymer. In this case, solvent (Sp) and non-solvent are typically selected so as to ensure the solvent (Sp) having higher volatility than the non-solvent, so that progressive evaporation, generally under controlled conditions, of the solvent (Sp) leads to the copolymer precipitation, and hence actual contact of the pre-shaped article with non-solvent medium.

When present in the polymer solution, pore forming agents are generally at least partially, if not completely, removed from the porous article in the non-solvent medium [NS], during this step of the method of article manufacture.

The method may further include additional treatment steps after shaping and precipitation, for instance steps of rinsing and/or stretching the porous article and/or a step of drying the same, especially when the article is a porous membrane.

For instance, the porous article may be additionally rinsed.

Further, the porous article may be advantageously stretched so as to increase its average porosity.

The porous article may be dried at a temperature of advantageously at least 30° C. Drying can be performed under air or a modified atmosphere, e.g. under an inert gas, typically exempt from moisture (water vapor content of less than 0.001% v/v). Drying can alternatively be performed under vacuum.

A suitable example of a method for forming a porous membrane from a polyaryl ether sulfone polymer is described in US2019/054429A1 (Solvay Specialty Polymers USA), incorporated herein by reference.

A non-porous (or dense) fiber, film, membrane, or part thereof (such as a layer or costing) according to the present invention may be prepared using polymer solution casting or polymer melt processing method such as extrusion casting. In such instances, the PAES copolymer may be the sole polymer in the non-porous article; or the non-porous article further comprises at least one other polymer.

After a polymer solution is casted as a film on a substrate, the solvent is generally evaporated to generate the non-porous film.

Generally the production of non-porous articles from a PAES copolymer-containing solution does not involve the use of non-solvent medium.

Non-porous articles can be generated by classical melt processing techniques like film, tube or pipe extrusion, wire coating, injection molding and the like. In all those processes the common denominator is the use of an equipment (extruder, injection molder), where the polymer is fed (in powder or pellets form), melted and then formed into a desired shape. The shaped article is then left to cool in air or water.

Non-porous articles can also be generated by solvent medium like in coating or casting. In such instances, the solvent is allowed to evaporate. In a typical industrial process to make a self-standing thin cast film, a polymer solution is fed through a slot die via a gear pump and cast on a moving support (belt). The solvent is let to evaporate in an oven chamber after casting. A polymer film is then detached from the carrier belt. See for example, Ulrich Siemann, “Solvent Cast technology—a versatile tool for thin film production”, in Progr. Colloid Polym. Sci. (2005) vol. 130: pages 1-14, Springer publisher.

Various techniques for making an article may be found in the book by Chang Dae Han entitled “Rheology and Processing of Polymeric Materials”, Vol 2 (2007), Oxford press, such as in Chapter 2: Plasticating Single-Screw Extrusion (pages 56-131), Chapter 6: Fiber Spinning (pages 257-302) & Chapter 8: Injection molding (pages 351-378).

### Applications

The PAES copolymer according to the present invention is particularly suitable for manufacturing articles intended for contact with an aqueous medium. The aqueous medium may include a biological fluid such as blood, serum, a food product such as beverages (e.g., fruit juice, milk, beer), water, wastewater, or any aqueous industrial process stream such as process water, cooling water.

In particular, the article may be used for medical applications such as hemodialysis membranes, for solid state battery applications, for polymer electrolyte membranes, for polymeric or solid state electrolytes, for aqueous medium filtration, such as reverse osmosis membranes, ultrafiltration membranes, microfiltration membranes, nanofiltration membranes, and/or ion-exchange membranes. The aqueous medium filtration may include food and beverage filtration, filtration for water purification, filtration for wastewater treatment and filtration for industrial process separations involving aqueous medium.

Among applications of use, mention can be made of healthcare applications, in particular medical applications, wherein the article comprising the PAES copolymer can advantageously be used in single-use or may be reusable.

### Method for Purifying an Aqueous Medium

A further aspect of the present invention may be directed to a method for purifying an aqueous medium, said method comprising at least a filtration step through a membrane, fiber(s) or film(s) comprising, or made from, the PAES copolymer according to the present invention.

Indeed the inventive PAES copolymer can be used in different filter membrane geometries. For instance, the PAES copolymer can be used in flat membranes and/or in capillary-like hollow fiber membranes. The aqueous medium flow toward these membranes may take in the form of a dead-end flow or of a cross flow.

In particular, the purification method may be used for purifying a human biological fluid, preferably a blood product, e.g., whole blood, plasma, serum, fractionated blood components or mixtures thereof. The purification is carried out in an extracorporeal circuit which may comprise at least one filtering device (or filter) comprising at least one membrane, fiber or film as described above.

As intended herein, a blood purification method through an extracorporeal circuit may comprise hemodialysis (FD) by diffusion, hemofiltration (HF), hemodyafiltration (HDF) and/or hemoconcentration. In HF, blood is filtered by ultrafiltration, while in HDF blood is filtered by a combination of FD and HF.

Blood purification methods through an extracorporeal circuit are typically carried out by means of a hemodialyzer, i.e., equipment designed to implement any one of FD, HF or HFD. In such methods, blood is filtered from waste solutes and fluids, like urea, potassium, creatinine and uric acid, thereby providing blood free of waste solutes and fluids.

Typically, a hemodialyzer for carrying out a blood purification method comprises a cylindrical bundle of hollow fibers of membranes, said bundle having two ends, each of them being anchored into a so-called potting compound, which is usually a polymeric material acting as a glue which keeps the bundle ends together. Potting compounds are known in the art and include notably polyurethanes. By applying a pressure gradient, blood is pumped through the bundle of membranes via the blood ports and the filtration product (the “dialysate”) is pumped through the space surrounding the filers.

### Method for Increasing Flexibility of a Bulk Aromatic Sulfone Polymer

Another aspect of the present invention is directed to a method for improving the flexibility of a high-Tg aromatic sulfone polymeric material, comprising adding the PAES copolymer of the present invention to a high-Tg bulk aromatic sulfone polymer to form a polymeric blend having increased flexibility compared to the bulk aromatic sulfone polymer. That is to say, the polymeric blend has a lower Tg than the Tg of the bulk aromatic sulfone polymer. The resulting polymeric blend is preferably used in forming membranes (e.g., hollow fiber membranes) suitable for hemodialysis or water filtration such as ultrafiltration, nanofiltration and microfiltration applications. The high-Tg bulk polymer is preferably selected from PSU, PPSU, PES, copolymers thereof, or blends thereof, having a Tg 180° C. The higher flexibility means that the ductibility upon bending of the polymeric blend is improved (less brittle material) compared to the bulk aromatic sulfone polymer.

The invention will be now described in more detail with reference to the following examples whose purpose is merely illustrative and not limitative of the scope of the invention.

### EXAMPLES

In these examples, short chain (6-C) ethylene oxide segments were incorporated into PES, PSU and PPSU polymeric chains via copolymerization of 1,2-bis(2-chloroethoxy)ethane (DCEO) and dichlorodiphenylsulfone (DCDPS) with a diol according to a one-pot synthesis procedure.

### Raw Materials

DCEO (1,2-bis(2-chloroethoxy)ethane or triethylene glycol dichloride), CAS No. 112-26-5, available from TCI America
DCDPS (4,4′-dichlorodiphenyl sulfone), CAS No. 80-07-9, available from Solvay Speciality Polymers USA
BP (4,4′-biphenol), CAS No. 92-88-6, available from TCI America
Bis A (2,2-bis(4-hydroxyphenyl)propane), CAS 80-05-7, available from Aldrich
Bis S (4,4′-dihydroxydiphenyl sulfone), CAS No. 80-09-1, available from Acros (now Thermo Scientific)
TMBPF (Tetramethylbisphenol F), CAS No. 5384-21-4, available from TCI America
TGE (triethylene glycol), CAS No. 112-27-6, available from TCI America
K₂CO₃ (potassium carbonate), CAS No. 584-08-7, available from Fisher or Aldrich
Sulfolane (tetrahydrothiophene 1,1-dioxide), CAS. No. 126-33-0, available from Alfa Aesar or Acros (now Thermo Scientific)
DMAc (dimethylacetamide), CAS No. 127-19-5, available from Alfa Aesar or Acros (now Thermo Scientific)
NMP (N-methylpyrrolidone), CAS No. 872-50-4, available from Acros (now Thermo Scientific)
Toluene, CAS No. 108-88-3, available from Acros (now Thermo Scientific) or Fisher
Methanol, CAS No. 67-56-1, available from Fisher PES: Veradel® PES 3300, CAS No. 25608-63-3, available from Solvay Specialty Polymers USA, LLC
PSU: UDEL® P-3500 LCD MB7, CAS No. 25154-01-2, available from Solvay Specialty Polymers USA, LLC
PPSU: RADEL® R-5000 CAS No. 31833-61-1, available from Solvay Specialty Polymers USA, LLC

### Test Methods

### GPC Method for Measuring Molecular Weight (Mn, Mw) (Sulfone Method)

The molecular weights (number average molecular weight Mn and weight average molecular weight Mw) were measured by gel permeation chromatography (GPC), using methylene chloride as a mobile phase. Two 5μ mixed D Size Exclusion Chromatography (SEC) columns with guard column from Agilent Technologies were used for separation. An ultraviolet detector of 254 nm was used to obtain the chromatogram. A flow rate of 1.5 ml/min and injection volume of 20 μL of a 0.2 w/v % solution in mobile phase was selected. Calibration was performed with 10 or 12 narrow molecular weight polystyrene standards from Agilent Technologies (Peak molecular weight range: 371,000 to 580 g/mol).

### Calibration Curve:

1) Type: Relative, Narrow calibration standard calibration
2) Fit: 3^{rd} order regression.

Integration and calculation: Empower Pro GPC software manufactured by Waters used to acquire data, calibration and molecular weight calculation. Peak integration start and end points were manually determined from significant difference on global baseline.

### DSC

Differential scanning calorimeter (DSC) was used to determine glass transition temperatures (Tg)—and melting temperature (Tm) if any—according to ASTM D3418. DSC experiments were carried out using a TA Instrument Q100. DSC curves were recorded by heating, cooling, re-heating, and then re-cooling the sample between 25° C. and 320° C. at a heating and cooling rate of 20° C./min. All DSC measurements were taken under a nitrogen purge. The reported Tg (and Tm if any) values were provided using the second heat curve unless otherwise noted.

### Measurement of Liquid Contact Angle (CA)

One way to characterize surface hydrophilicity is to measure contact angles. The contact angles towards water and hexadecane on dry dense polymeric films were evaluated at 25° C. by using the Contact Angle System OCA Dataphysics according to ASTM D 5725-99. Values are average of at least 10 measurements. Volume drop was always 2 microliter. With this CA method, the contact angle decreases as hydrophilicity is increased.

### Measurement of Air Contact Angle Via Captive Air Bubble Method (CAB)

As mentioned above, one can measure contact angle in order to characterize surface hydrophilicity. Because of absorption phenomena, this method is poorly suited to measure contact angles of porous hydrophilic samples, consequently contact angles were measured by the Captive Air Bubble (CAB) method. Indeed, this method measures the contact angle of an air bubble at a surface immersed in a liquid, in this case water. The CAB method has several advantages for membrane characterization. As the membranes are already wet, swelling and absorption are suppressed. In addition, this avoids surface contamination, chemical reorganization and drying-induced degradation. Moreover, the sample surface is in contact with a saturated and well-controlled environment, thus improving reproducibility.

Air Contact Angle measurements were carried out by CAB method at room temperature, using an adapted environment-controlled chamber filled with deionized water. Measurements were performed on an optical tensiometer (Attension Theta Flex, BIOLIN) equipped with a high quality monochromatic cold LED and a high resolution (1984×1264) digital camera. Prior to analysis, the wet (in water) samples were wrapped on a 15×15 mm glass substrate which was fixed on a holder, with double-sided tape, and then immersed in DI water. A 2 μL air bubble was then dropped on the sample surface with a J shaped syringe, and the ACA was measured. The presented contact angle values were the average of 10 measurements performed on the same sample. With this CAB method, higher values mean higher hydrophilicity of the sample.

### Example 1 (According to the Invention)

One-Pot Synthesis of a PPSU-EO Using DCEO+DCDPS (with a 50:50 Molar Ratio) and BP as Diol

The polymerization to make the PPSU-EO copolymer E1 is illustrated in Scheme 1. For copolymer E1, T is a bond and m=n=0.5 in this scheme.

The polycondensation was performed in a 2-L reaction kettle with a 4-neck lid equipped with mechanical stirrer, nitrogen inlet, and internal thermocouple. The kettle was charged
with a monomer mixture containing DCDPS (90.06 g, 0.3136 mol) as dihalo monomer (AS), 1,2-bis(2-chloroethoxy)ethane (28.67 g, 0.3136 mol) as dihalo monomer (AO) and biphenol (116.25 g, 0.6243 mol) as dihydroxy monomer (B),
with potassium carbonate (90.60 g, 0.6555 mol) as the alkali metal carbonate, and
with sulfolane (1067.4 g) as solvent [S] and toluene (15 mL) as azeotropic forming co-solvent,
   to achieve a reaction mixture containing 25 wt. % solids.

The molar ratio of dihydroxy (B)/[dihalo (AO)+(AS)] was 0.9954.

The molar ratio of the equivalents of potassium (alkali metal) per equivalent of hydroxyl group (OH) in the diol (B) [eq. (K)/eq. (OH)] was 1.05.

The molar ratio of the dihalo (AS) with respect to the combined dihalo (AO)+(AS) was 50 mol %.

The reactants were dried via azeotropic distillation of aqueous toluene. The reaction mixture was heated to and maintained at 210° C. overnight under nitrogen.

The reaction mixture was then diluted with NMP (1247.01 g) to achieve a 15 wt. % solids, and the diluted reaction mixture was pressure filtered through a 2.7 micron glass fiber filter at ˜40 psi. The diluted reaction mixture comprising a mixture of NMP and sulfolane was coagulated in a blender containing room temperature dionized water (non-solvent), then washed 4 times in room-temperature water (about 20-25° C.) and three times with methanol, then dried overnight in an oven at 100° C.

The ethylene oxide content for the PPSU-EO copolymer E1 corresponded to 17 wt. %.

### Example 2 (According to the Invention)

One-Pot Synthesis of a PES-EO Copolymer E2 Using DCEO+DCDPS (with a 50:50 Molar Ratio) and Bis S as Diol

The polymerization to make the PES-EO copolymer E2 is illustrated in Scheme 1. For copolymer E2, T is SO₂ and m=n=0.5 in this scheme.

The 2-L reaction kettle described above was charged with:
a monomer mixture containing DCDPS (90.06 g, 0.3136 mol) as dihalo monomer (AS), 1,2-bis(2-chloroethoxy)ethane (28.67 g, 0.3136 mol) as dihalo monomer (AO) and bisphenol S (156.24 g, 0.6243 mol) as dihydroxy monomer (B),
potassium carbonate (90.60 g, 0.6555 mol) as the alkali metal carbonate, and
sulfolane (923.26 g) as solvent [S] and toluene (15 mL=13 g) as azeotropic forming co-solvent,
   to achieve a reaction mixture with 30 wt. % solids.

The molar ratio of dihydroxy (B)/[dihalo (AO)+(AS)] was 0.9954.

The molar ratio of the equivalents of potassium (alkali metal) per equivalent of hydroxyl group (OH) in the diol (B) [eq. (K)/eq. (OH)] was 1.05.

The molar content of the dihalo (AS) with respect to the combined dihalo (AO)+(AS) in the reaction mixture was 50 mol. %, or the molar AO/AS ratio was 50/50.

The reaction mixture was heated to and maintained at 220° C. for 4 hours.

The steps of drying the reaction mixture and isolation of the polymer were the same as described in Example 1.

The weight content of the ethylene oxide segments for PES-EO copolymer E2 corresponded to 14 wt. %.

### Counter-Example 1 (not According to the Invention)

One-Pot Synthesis of a PPSU-EO Copolymer CE1 Using DCEO+DCDPS (with a 75:25 Molar Ratio) and BP as Diol

The polymerization to make the PPSU-EO copolymer CE1 is illustrated in Scheme 1. For copolymer CE1, T is a bond; m=0.75; n=0.25 in this scheme.

The same one-pot procedure as described from Example 1 was carried out for this counter-example, except that the molar ratio of DCEO=dihalo (AS) to the combined dihalo DCEO+DCDPS in the reaction mixture was 75 mol %.

The weight content of the ethylene oxide segments constituted 27 wt % of the PPSU-EO copolymer CE1.

### Example 3 (According to the Invention)

One-Pot Synthesis of a PPSU-EO copolymer E3 using DCEO+DCDPS (with a 75:25 molar ratio) and Bis S as diol

The polymerization to make the PES-EO copolymer E3 is illustrated in Scheme 1. For copolymer E3, T is SO₂; m=0.75; n=0.25 in this scheme.

The same one-pot procedure as described from Example 2 was carried out except that the molar ratio of the dihalo (AS) with respect to the combined dihalo (AO)+(AS) in the reaction mixture was 75 mol % or the molar ratio AO/AS=1/3.

The weight content of the ethylene oxide segments constituted 22 wt % of the PPES-EO copolymer E3.

### Example 4 (According to the Invention)

One-Pot Synthesis of a PSU-EO Copolymer E4 Using DCEO+DCDPS (with a 4:96 Molar Ratio) and Bis a as Diol

The polymerization to make the PSU-EO copolymer E4 is illustrated in Scheme 1. For copolymer E4, T is C(CH₃)₂; m=0.04; n=0.96 in this scheme.

The kettle described above was charged with
with a monomer mixture containing DCDPS (155.62 g, 0.5419 mol) as dihalo monomer (AS), 1,2-bis(2-chloroethoxy)ethane (4.23 g, 0.02261 mol) as dihalo monomer (AO) and bisphenol A (128.26 g, 0.5618 mol), as dihydroxy monomer (B),
with potassium carbonate (81.54 g, 0.59 mol) as the alkali metal carbonate, and
with NMP (873.81 g) as solvent [S] and toluene (20 mL) as azeotropic forming co-solvent, to achieve a reaction mixture with 30 wt. % solids.

The molar ratio of dihydroxy (B)/[dihalo (AO)+(AS)] was 0.9952.

The molar ratio of the equivalents of potassium (alkali metal) per equivalent of hydroxyl group (OH) in the diol (B) [eq. (K)/eq. (OH)] was 1.05.

The molar content of the dihalo (AS) with respect to the combined dihalo (AO)+(AS) in the reaction mixture was 4 mol %, or the AO/AS molar ratio was 4/96.

The reactants were dried via azeotropic distillation with toluene then stirred at 120 C overnight. The reaction mixture was heated to and maintained at 180° C. for 6 hours. The step of isolation of the polymer was the same as described in Example 1.

The weight content of the ethylene oxide segments based on total copolymer weight constituted 1.2 wt % of the PSU-EO copolymer E4.

### Characterisation of PAES Copolymers E1, CE1, E2, E3, E4

The Mw and Tg of the PAES copolymers (E1), (E2), (E3), (E4) and (CE1) were measured by the methods described earlier, and are provided in Table 1.

TABLE 1

| | E1 | CE1 | E2 | E3 | E4 |
|---|---|---|---|---|---|
| | PPSU-EO | PPSU-EO | PES-EO | PES-EO | PSU-EO |
| relative | 50 | 75 | 50 | 75 | 4 |
| DCEO mol | | | | | |
| %* | | | | | |
| DCEO mol | 25 | 37.5 | 25 | 37.5 | 2 |
| %** | | | | | |
| diol | biphenol | biphenol | Bis S | Bis S | Bis A |
| EO wt. %** | 17 | 27 | 14 | 22 | 1.2 |
| M_{w}, g/mol | 59200 | 19800 | 44400 | 36900 | 51200 |
| Mₙ, g/mol | 18500 | 7900 | 13550 | 12700 | 13700 |
| PDI | 3.19 | 2.51 | 3.28 | 2.91 | 3.74 |
| T_{g}, ° C. | 120 | (Tₘ₂ 164) | 134 | 98 | 183 |

*relative mol. % DCEO based on combined number of moles of DCEO and DCDPS in reaction mixture
**mol. % DCEO based on combined number of moles of DCEO + DCDPS + diol in reaction mixture
*** wt. % EO being based on the weight of EO present in total copolymer weight

PPSU-EO Copolymer E1 and PES-EO copolymer E2 constituting 50/50 molar ratio DCEO/DCDPS exhibited good molecular weight (M_{w}=59200, 44400 g/mol) and thermal properties (Tg=120, 134° C.).

PSU-EO Copolymer E4 constituting a DCEO/DCDPS molar ratio of 4/96 exhibited good molecular weight (M_{w}=51200 g/mol) and thermal properties (Tg=183° C.).

PES-EO copolymer E3 with Bis S, DCEO and DCDPS constituting a DCEO/DCDPS molar ratio of 75/25 exhibited good molecular weight (M_{w}=36900 g/mol), but had a low Tg (98° C.); such a low Tg increased the flexibility of copolymer E3, and may provide an advantage in membrane applications when there is a desire to increase polymer ductibility.

PPSU-EO copolymer CE1 with biphenol, DCEO and DCDPS constituting a DCEO/DCDPS molar ratio of 75/25 exhibited low molecular weight (M_{w}=19800 g/mol) and appeared semi-crystalline with the detection of a melting temperature of 164° C.

### Solubility Testing of PAES Copolymers E1, E2

Samples of the PAES copolymers E1 and E2 were tested for solubility in NMP and DMAc. For the solubility study, the polymer samples were dissolved in NMP and DMAc at 5, 10, 15, and 20 wt. %, heated to 65° C., cooled to ambient conditions and held for 7 days, after which time observations of transparency were recorded. The results for solubility for PAES copolymers E1 and E2 are provided in Tables 2 and 3, respectively.

TABLE 2

| Tests No. | AA | BB | CC | DD |
|---|---|---|---|---|
| PPSU-EO copolymer E1, wt. % | 5 | 20 | 5 | 20 |
| DMAc, wt. % | 95 | 80 | — | — |
| NMP, wt. % | — | — | 95 | 80 |
| Solubility at 65° C. | clear | clear | clear | clear |
| Solution appearance @ | cloudy | cloudy | slightly | cloudy |
| ambient temp. after 7 days | | | hazy | |
| Homogeneity | Y | Y | Y | Y |

TABLE 3

| Tests No. | EE | FF | GG | HH |
|---|---|---|---|---|
| PES-EO copolymer E2, wt. % | 5 | 20 | 5 | 20 |
| DMAc, wt. % | 95 | 80 | — | — |
| NMP, wt. % | — | — | 95 | 80 |
| Solubility at 65° C. | clear | clear | clear | clear |
| Solution appearance @ | clear | slightly | clear | clear |
| ambient temp. after 7 days | | hazy | | |
| Homogeneity | Y | Y | Y | Y |

Tables 2 and 3 show that homogeneous solutions were obtained across a range (5-20 wt %) of PPSU-EO and PES-EO copolymer content.

The PES-EO copolymer E2 showed better solubility compared to PPSU-EO copolymer E1.

### Compatibility Testing of PAES Copolymers E1 and E2

Solution compatibility of the PAES copolymers E1 and E2 was also evaluated in the DMAc and NMP solvents and compared with PSU and PES homopolymers.

Compatibility of blends at a total of 20 wt. % of polymers in solvent/polymer mixtures was evaluated for a range of PAES copolymer to homopolymer weight ratios: 5/95, 10/90, 20/80, 50/50, 80/20, 90/10 and 95/5. Solvent/polymer mixtures were heated to 65° C., then cooled to ambient temperature. Observations of transparency and phase separation were recorded upon initial cooling, and after 7 days of standing at ambient temperature.

The results for compatibility for PPSU-EO copolymer E1 with PSU and PES are provided in Tables 4 and 5, respectively.

TABLE 4
Bicomponent Solutions with PPSU-EO copolymer E1 + PSU

| Test No. | A | B | C | D |
|---|---|---|---|---|
| PPSU-EO copolymer E1, wt. % | 4 | 16 | 4 | 16 |
| PSU, wt % | 16 | 4 | 16 | 4 |
| DMAc, wt. % | 80 | 80 | — | — |
| NMP, wt. % | — | — | 80 | 80 |
| Solubility at 65° C. | clear | clear | clear | clear |
| Solution appearance @ | cloudy | cloudy | slightly | cloudy |
| ambient temp. after 7 days | | | hazy | |
| Homogeneity | Y | Y | Y | Y |

TABLE 5
Bicomponent Solutions with PPSU-EO copolymer E1 + PES

| Test No. | E | F | G | H |
|---|---|---|---|---|
| PPSU-EO copolymer E1, wt. % | 4 | 16 | 4 | 16 |
| PES, wt % | 16 | 4 | 16 | 4 |
| DMAc, wt. % | 80 | 80 | — | — |
| NMP, wt. % | — | — | 80 | 80 |
| Solubility at 65° C. | clear | clear | clear | clear |
| Solution appearance @ | cloudy | cloudy | cloudy | cloudy |
| ambient temp. after 7 days | | | | |
| Homogeneity | Y | Y | Y | Y |

The results for compatibility for PES-EO copolymer E2 with PSU and PES are provided in Tables 6 and 7, respectively.

TABLE 6
Bicomponent Solutions with PES-EO copolymer E2 + PSU

| Test No. | I | J | K | L |
|---|---|---|---|---|
| PES-EO Copolymer E2, wt. % | 4 | 16 | 4 | 16 |
| PSU, wt % | 16 | 4 | 16 | 4 |
| DMAc, wt. % | 80 | 80 | — | — |
| NMP, wt. % | — | — | 80 | 80 |
| Solubility at 65° C. | hazy | hazy | clear | hazy |
| Solution appearance @ | hazy | hazy | slightly | hazy |
| ambient temp. after 7 days | | | hazy | |
| Homogeneity | Y | Y | Y | Y |

TABLE 7
Bicomponent Solutions with PES-EO copolymer E2 + PES

| Test No. | M | N | O | P |
|---|---|---|---|---|
| PES-EO Copolymer E2, wt. % | 4 | 16 | 4 | 16 |
| PES, wt % | 16 | 4 | 16 | 4 |
| DMAc, wt. % | 80 | 80 | — | — |
| NMP, wt. % | — | — | 80 | 80 |
| Solubility at 65° C. | clear | clear | clear | clear |
| Solution appearance @ | slightly | clear | clear | clear |
| ambient temp. after 7 days | hazy | | | |
| Homogeneity | Y | Y | Y | Y |

Solutions of blends exhibited different degrees of clarity, haziness and cloudiness. None showed separation into differentiated layers.

PES-EO Copolymer E2 showed good homogeneity at room temperature.

PPSU-EO Copolymer E1 showed homogeneity with cloudiness and required heating to 40° C. for film preparation. Data in Tables 3, 6 and 7 showed that PES-EO copolymer E2 and blends of PES-EO copolymer E2 with PES provided more stable solutions for membrane coagulation compared to other combinations.

### Example 5—Dense Films (Non-Porous Articles)

### Dense Films Preparation (Solvent DMAc)

Dense films were prepared from polymer solutions comprising 20% wt. % polymer concentration in DMAc (the wt % being based on total solution weight).

In Test No. Q, the polymer in the polymer solution was PPSU-EO copolymer E1. In Test No. R, the polymer in the polymer solution was a blend of PPSU-EO copolymer E1 and PPSU using 14.3 wt % PPSU-EO copolymer E1 based on combined weights of copolymer E1+PPSU. In Test No. S, the polymer in the polymer solution was PES-EO copolymer E2. In Test No. T, the polymer in the polymer solution was a blend of PES-EO copolymer E2 and PES using 14.3 wt % PES-EO copolymer E2 based on combined weights of copolymer.

Dense films made from the PES-EO copolymer E2 were prepared from 30% w/w % polymer concentration solutions in DMAc.

The procedure to make flat dense polymeric films were as follows. The polymeric solution containing the polymer and the DMAc solvent was casted over a suitable smooth glass support by means of an automatized casting knife at 40° C. The knife gap was set at 500 μm. After casting the films, the solvent was left to evaporate in a vacuum oven at 130° C. for 4 hours.

### Characterization of Dense Films

TABLE 8

| | | | | | | U |
|---|---|---|---|---|---|---|
| Test No. | | Q | R | S | T | (comparative) |
| Polymer | PPSU-EO | 20 | 2.14 | — | — | — |
| Solution | copolymer | | | | | |
| (contents in | E1 | | | | | |
| wt. %) | PPSU | — | 12.86 | — | — | — |
| | PES-EO | — | — | 30 | 2.14 | — |
| | copolymer | | | | | |
| | E2 | | | | | |
| | PES | — | — | — | 12.86 | 20 |
| | DMAc | 80 | 85 | 70 | 85 | 80 |

Properties of dense films

| | | | | | |
|---|---|---|---|---|---|
| Solution appearance @ | cloudy | cloudy | cloudy | clear | clear |
| ambient temp. & 7 days | | | | | |
| Solution homogeneity | Y | Y | Y | Y | Y |
| at 7 days | | | | | |
| Casting Temperature | 40° C. | 40° C. | RT | RT | RT |
| Film homogeneity | good | good | good | good | good |
| Contact Angle, Dry film, | 93 ± 3.5 | — | 77 ± 2.5 | — | 90 ± 5 |
| water | | | | | |
| CAB, water | 93 ± 3.5 | — | 108 ± 4 | — | 97 ± 4 |

The dense film in Test No. S (Table 8), which incorporated PES-EO copolymer E2 as sole or blend component exhibited higher hydrophilicity than films based upon PES and compared to films based upon PPSU-EO copolymer E1.

### Example 6—Porous Membrane (Porous Article)

### Porous Membrane Preparation (Solvent DMAc)

Porous membranes were prepared either from PES (using a polymeric dope solution with 20 w/w % polymer concentration in DMAc) and from a blend of PES+PES-EO copolymer E2 using a PES:E2 mass ratio of 3:1 (using a polymeric dope solution with 20 w/w % polymer concentration in DMAc).

Flat sheet porous membranes were prepared by casting the polymeric dope solution over a suitable smooth glass support by means of an automatized casting knife. Membrane casting was performed by keeping the dope solution, the casting knife and the support temperatures at 25° C. in order to prevent premature precipitation of the polymer. The knife gap was set to 250 μm. After casting, films of porous membranes were immediately immersed in a coagulation bath in order to induce phase inversion (polymer precipitation). The coagulation bath consisted of pure de-ionized water. After coagulation, the membranes were washed several times in pure water during the following days to remove residual solvent. The membranes were stored (wet) in water and then dried for further analyses.

### Porous Membrane Characterization

TABLE 9

| Test No. | | V | W (comparative) |
|---|---|---|---|
| Polymer dope | PES-EO Copolymer | 5 | — |
| solution | E2, wt. % | | |
| | PES, wt % | 15 | 20 |
| | DMAc, wt. % | 80 | 80 |

| | | |
|---|---|---|
| Membrane thickness, microns | 100 | 100 |
| Contact angle, CA (water) | 52 ± 3 | 80 ± 5 |

The porous film from Test No. V (Table 9) which incorporated PES-EO copolymer E2 as a blend component with PES with a weight ratio of 1:3 (E2:PES) [or 25 wt % E2 based on combined weights of E2+PES] exhibited higher hydrophilicity than a film based from solely a PES homopolymer (see Test No. W).

### Example 7—Hemocompatibility Testing

The porous membrane made with the PES-EO copolymer E2—see Test No. V in Example 5—was also used for hemocompatibility tests [Partial thromboplastin time (aPTT) and Prothrombin time (PT)].

### Blood Coagulation Tests

This testing measures a coagulation (clotting) time of the plasma.

Note that the control sample is blood which was not in contact with the specimen.

Note that the Test Performed (Activated)

Partial thromboplastin time (aPTT) and Prothrombin time (PT) tests were performed after the contact with the porous flat sheet membrane. The procedure was the following:

Human fresh whole blood (blood from patients chosen randomly and not treated with anticoagulant therapy) was put in a vial containing sodium citrate.

The contact was performed by immersing the membranes in the vials with whole blood in order to reach a surface/volume ratio of 6 cm2/ml and incubated for 30 minutes at a temperature of 37° C.±1° C. in dynamic condition (orbital stirrer).

This blood was then centrifuged @3000 G for 20 minutes. aPTT and PT were executed on the supernatant plasma obtained in this way.

In the case of aPTT test plasma was finally mixed with a colloidal activator (magnesium aluminum silicate) followed by the addition of calcium chloride (solution with concentration of 0.025 mol/l) and clotting time was measured.

In the case of PT test plasma was finally mixed with thromboplastin (rabbit brain thromboplastin) followed by the addition of calcium chloride (solution with concentration of 0,025 mol/l) and clotting time was measured.

Results (coagulation times expressed in seconds) of both aPTT and PT tests are reported in Table 10.

TABLE 10

| Sample | aPTT | PT |
|---|---|---|
| Control sample (blood not in | 28 | 13.4 |
| contact with the membrane) | | |
| PES + PES-EO copolymer E2 | 26.2 | 12.8 |
| (weight ratio 3:1) (Test No. V) | | |

Plasma extracted from the blood in contact with these membranes coagulated roughly at the same speed of the plasma not in contact with any membrane and hence the PES-EO copolymer E2 had no negative effect on the coagulation cascade of the blood, compared to what is observed with a PES membrane.

### Counter-Example 2 (not According to the Invention)

This counter-example was generated to compare the polymerization performance using a polyalkylene oxide having two hydroxyls: HO-AO-OH monomer (such as a PEG) as taught in the prior art in lieu of the CI-AO-CI monomer used in the present invention. Triethylene glycol (TEG) was selected for this counter-example because it has the same ethylene oxide structure (—CH₂—CH₂—O—CH₂—CH₂—O—CH₂—CH₂—O—) as 1,2-bis(2-chloroethoxy)ethane (DCEO).

One-Pot Synthesis of a PES-EO Copolymer CE2 Using TEG+Bis S (with a 25:75 Molar Ratio) and DCDPS as Sole Dihalo

The polymerization to make the PES-EO copolymer CE2 is illustrated in Scheme 3.

This counter-example 2 was carried out in a similar fashion as Example 3 in US2016/0075850A1 in which PEG2050, Bisphenol S and DCDPS in NMP and without azeotrope forming solvent using about 50 wt. % solids in NMP and using a 5% molar excess (with respect to diols) of potassium carbonate were reacted at 190° C. for 6 hours, except that the PEG2050 was replaced by triethylene glycol (TEG) in this counter-example. The resulting ethylene oxide weight content in the copolymer CE2 was 7.3 wt. % with respect to all monomers (using a 12.5 mol. % TEG, 37.5 mol. % Bis S, 50 mol. % DCDPS), similar to the 7.2 wt. % ethylene oxide weight content (PEG2050) in Ex. 3 of US2016/07850A1.

### Characterisation of Sample (CE2)

The Mw, Mn, PDI, and Tg of the resulting copolymer CE2 were measured by the methods described earlier, and are provided in Table 11.

It was observed that the preparation method taught in US2016/07850A1 using triethylene glycol resulted in producing a sample (CE2) of very low molecular weight (Mw=4550 g/mol). This oligomer would not be suitable for make articles such as membranes because it would have insufficient viscosity (due to its low Mw).

TABLE 11

| Test for Copolymer CE2 | PES-EO |
|---|---|
| DCDPS mol % | 50 |
| Bis S mol % | 37.5 |
| TEG mol %** | 12.5 |
| EO wt. %** | 7 |
| M_{w}, g/mol | 4550 |
| Mₙ, g/mol | 3090 |
| PDI | 1.47 |
| T_{g}, ° C. | 147 |

**mol. % TEG based on combined number of moles of TEG + DCDPS + Bis S in reaction mixture
*** wt. % EO being based on the weight of EO present in total copolymer weight

### Example 8 (According to the Invention)

One-Pot Synthesis of TMBPF-EO Sulfone Copolymers E5 TO E10 Using DCEO+DCDPS (with Molar Ratios of 12/88, 25/75, 50/50) and TMBF as Diol

Copolymer samples E5 to E10 were made according to the general procedure described below.

### General Procedure for Making the TMBPF-EO Sulfone Copolymers:

The polymerization to make the TMBPF-EO copolymer samples E5 to E10 is illustrated in Scheme 2. For copolymers E5 to E10, m′ varied from 0.12 to 0.50 while n′=1-m′ in this scheme.

The polycondensation was performed in a 500-milliliter round bottom flask (reactor) equipped with an overhead mechanical agitator, a nitrogen inlet, dean-stark trap with reflux condenser.

The reactor was charged
with a monomer mixture containing DCDPS as dihalo monomer (AS), 1,2-bis(2-chloroethoxy)ethane as dihalo monomer (AO) and tetramethyl bisphenol F as dihydroxy monomer (B),
with potassium carbonate as the alkali metal carbonate, and
with sulfolane or NMP or DMAc as solvent [S] and toluene as azeotropic forming co-solvent,
   whereby the amounts of the monomers were selected to achieve a polymer content of 30 wt % in the reaction mixture.

The amount of potassium carbonate used in the reaction mixture, when expressed by the ratio of the equivalents of alkali metal (Me) per equivalent of hydroxyl group (OH) [eq. (Me)/eq. (OH)] was generally from 1.05 to 1.30 eq. (K)/eq. (OH).

The molar ratio in the monomers mixture between the overall amount of hydroxyl groups from TMBPF [(monomer (B)] and the overall amount of halo groups from DCEO and DCDPS [monomers) (AO)+(AS)] was 1.0.

Before starting heat via external oil bath, nitrogen flow was established and the reaction mixture was purged with nitrogen for 15 minutes. The reaction mixture comprising the monomers was stirred with the overhead mechanical agitator and warmed using an oil bath controlled at the target azeotropic distillation temperature for the removal of water and toluene at 155° C. This temperature was maintained for 60-90 minutes, while the azeotropic distillate was collected then drained from the trap. The bath temperature was increased from 155° C. to the appropriate reaction temperature (175° C. when DMAc was used, 190° C. when NMP was used, or 210° C. when sulfolane was used) over 30-60 minutes. Water, a byproduct of the polymerization reaction, was continuously stripped out of the reactor and collected in the dean-stark trap. Upon reaching the target internal temperature, the reaction was held at that temperature for a period of reaction time suitable until a desired M_{w} is achieved. The reaction time period varied from 4 to 16 hours depending on the reaction temperature/medium.

Once the desired molecular weight was achieved, the polymerization was terminated by diluting with solvent (NMP, DMAc or NMP) to 15 wt. % solids, reducing the internal temperature back to ambient (21° C.), and adding acetic acid to convert the sodium phenolate chain ends back to phenols. The diluted polymer solution was filtered through a 2.7 μm glass fibre filter pad under pressure to remove salts. The polymer solution was poured in to a Waring blender containing a non-solvent (water, methanol, or 50/50 vol./vol. methanol/water) for the copolymer to be precipitated, using a ratio of 1:5 polymer solution to non-solvent to obtain a white solid (polymer precipitate). The isolated white solid was then washed with the same non-solvent 6 times with filtration between each wash, then vacuum filtered, and dried for 12 hours in a vacuum oven at 100-120° C.

### Counter-Example 3 (not According to the Invention)

### One-Pot Synthesis of a TMBPF Sulfone Homopolymer CE3 Using DCDPS as Sole Dihalo Monomer and TMBPF as Sole Diol

The homopolymer CE3 made from TMBPF and DCDPS was made according to the general procedure used to make the TMBPF-EO sulfone copolymers (E5)-(E6) in sulfolane, except that DCEO was omitted.

The initial reaction mixtures and reaction conditions for copolymer samples (E4)-(E9) and homopolymer sample (CE3) are provided in Table 12.

TABLE 12

| | Reaction mixture * | | | | | | Reaction | |
|---|---|---|---|---|---|---|---|---|
| | | | TMBPF | DCEO | DCDPS | | conditions | |
| | | Solvent | (B) | (AO) | (AS) | Eq. K/ | Temp | time |
| Sample | Solvent | g | mol | mol | mol | Eq. OH | ° C. | hrs |
| CE3 | Sulfolane | 70 | 0.064 | — | 0.064 | 1.05 | 210 | 6 |
| E5 | Sulfolane | 180 | 0.157 | 0.039 | 0.118 | 1.05 | 210 | 6 |
| E6 | Sulfolane | 182 | 0.168 | 0.084 | 0.084 | 1.05 | 210 | 6 |
| E7 | DMAc | 169 | 0.143 | 0.017 | 0.126 | 1.30 | 175 | 16 |
| E8 | DMAc | 131 | 0.115 | 0.029 | 0.086 | 1.05 | 175 | 16 |
| E9 | DMAc | 182 | 0.168 | 0.084 | 0.084 | 1.30 | 175 | 16 |
| E10 | NMP | 157 | 0.150 | 0.038 | 0.113 | 1.30 | 190 | 6 |

* contains 30 wt. % solids; a monomer molar ratio TMBPF/(DCEO + DCDPS) = 1

The molecular weights Mn and M_{w} measured by GPC, PDI and Tg are provided in Table 13.

TABLE 13

| | | relative | DCEO | EO | | | | |
|---|---|---|---|---|---|---|---|---|
| | | DCEO | mol. % | wt. % | Mₙ | M_{w} | | Tg |
| Samples | Solvent | mol. %* | ** | *** | kDa | kDa | PDI | ° C. |
| CE3 | Sulfolane | 0 | 0 | 0 | 17,660 | 57,258 | 3.24 | 229 |
| E5 | Sulfolane | 25 | 12.5 | 7 | 18,981 | 66,056 | 3.48 | 173 |
| E6 | Sulfolane | 50 | 25 | 15 | 11,265 | 25,040 | 2.22 | 109 |
| E7 | DMAc | 12 | 6 | 3.5 | 14,784 | 35,797 | 2.42 | 181 |
| E8 | DMAc | 25 | 12.5 | 7 | 16,990 | 44,565 | 2.62 | 173 |
| E9 | DMAc | 50 | 25 | 15 | 10,037 | 21,353 | 2.15 | 109 |
| E10 | NMP | 25 | 12.5 | 7 | 12,819 | 39,822 | 3.11 | 175 |

*relative mol. % DCEO based on total number of moles of DCEO + DCDPS in reaction mixture
** mol. % DCEO based on combined number of moles of DCEO + DCDPS + Bis S in reaction mixture
*** wt. % EO being based on the weight of EO present in total copolymer weight

### Counter-Example 4 (not According to the Invention)

This counter-example was generated to compare the polymerization performance using a HO-EO-OH monomer as taught in the prior art in lieu of the CI-EO-CI monomer (DCEO) used in the present invention. Triethylene glycol (TEG) was selected for this counter-example because it has the same ethylene oxide structure (—CH₂—CH₂—O—CH₂—CH₂—O—CH₂—CH₂—O—) as 1,2-bis(2-chloroethoxy)ethane (DCEO).

One-Pot Synthesis of a PES-EO Copolymer CE4 Using TEG+TMBPF (with a 25:75 Molar Ratio) and DCDPS as Sole Dihalo

The polymerization to make the TMBPF-EO copolymer CE4 is illustrated in Scheme 4.

This counter-example was carried out in a similar fashion as Example 3 in US 2016/0075850A1 in which PEG2050, Bis S and DCDPS in NMP and without azeotrope forming solvent using about 50 wt. % solids in NMP and using a 5% molar excess (with respect to diols) of potassium carbonate were reacted at 190° C. for 6 hours, except that the PEG2050 was replaced by triethylene glycol (TEG) and Bis S was replaced with TMBPF in this counter-example. The resulting ethylene oxide weight content in the copolymer CE5 was 7.3 wt. % with respect to all monomers (using a 12.5 mol. % TEG, 37.5 mol. % TMBPF, 50 mol. % DCDPS), similar to the 7.2 wt. % ethylene oxide weight content (PEG2050) in Ex. 3 of US2016/07850A1.

### Characterisation of Sample CE4

The Mw, Mn, PDI, and Tg of the resulting copolymer CE4 were measured by the methods described earlier, and are provided in Table 14.

It was observed that the preparation method taught in US2016/07850A1 using made triethylene glycol resulted in producing a sample (CE4) with TMBPF as sole diol of very low molecular weight (Mw of ca. 4000 g/mol, Mn of ca. 2550 g/mol). This oligomer CE4 would not be suitable for make articles such as membranes because due to its low molecular weight, it would have insufficient viscosity.

TABLE 14

| | Copolymer CE4 |
|---|---|
| DCDPS mol % | 50 |
| TMBPF mol % | 37.5 |
| TEG mol %** | 12.5 |
| EO wt. %** | 7 |
| M_{w}, g/mol | 3989 |
| Mₙ, g/mol | 2553 |
| PDI | 1.56 |
| T_{g}, ° C. | 159 |

### Characterization of Dense Film

** mol. % TEG based on combined number of moles of TEG+DCDPS+TMBPF in reaction mixture
*** wt. % EO being based on the weight of EO present in total copolymer weight

### Example 9—Dense Films (Non-Porous Articles)

### Dense Films Preparation (Solvent DMAc)

Dense films made was prepared using a 20 w/w % polymer concentration solution in DMAc in the same manner as described in Example 5. The polymer samples used were TMBBF-EO copolymer sample E7 [made from 6 mol % DCEO relative to total moles of all monomers] and also a blend of TMBBF-EO copolymer samples E5 and E8 [both made from 12.5 mol % DCEO relative to total moles of all monomers].

TABLE 15

| | | Test No. | | |
|---|---|---|---|---|
| | | | | U |
| | | X | Y | (comparative) |
| Polymer | Blend of TMBBF- | — | 20 | — |
| Solution | EO copolymers (E5 | | | |
| (contents | & E8 | | | |
| in wt. %) | TMBBF-EO | 20 | — | 20 |
| | copolymer E7 | | | |
| | DMAc | 80 | 80 | 80 |

Properties of dense films

| | | | |
|---|---|---|---|
| Contact Angle, water | 75.3 ± 6 | 78 ± 4.9 | 90 ± 5 |

The dense film in Tests No. X and Y (Table 15) made from TMBPF-EO copolymers exhibited higher hydrophilicity than a dense film made from PES.

Should the disclosure of any patents, patent applications, and publications which are incorporated herein by reference conflict with the description of the present application to the extent that it may render a term unclear, the present description shall take precedence.

Accordingly, the scope of protection is not limited by the description set out above, but is only limited by the claims which follow. Each and every claim is incorporated into the specification as an embodiment of the present invention. Thus, the claims are a further description and are an addition to the preferred embodiments of the present invention.

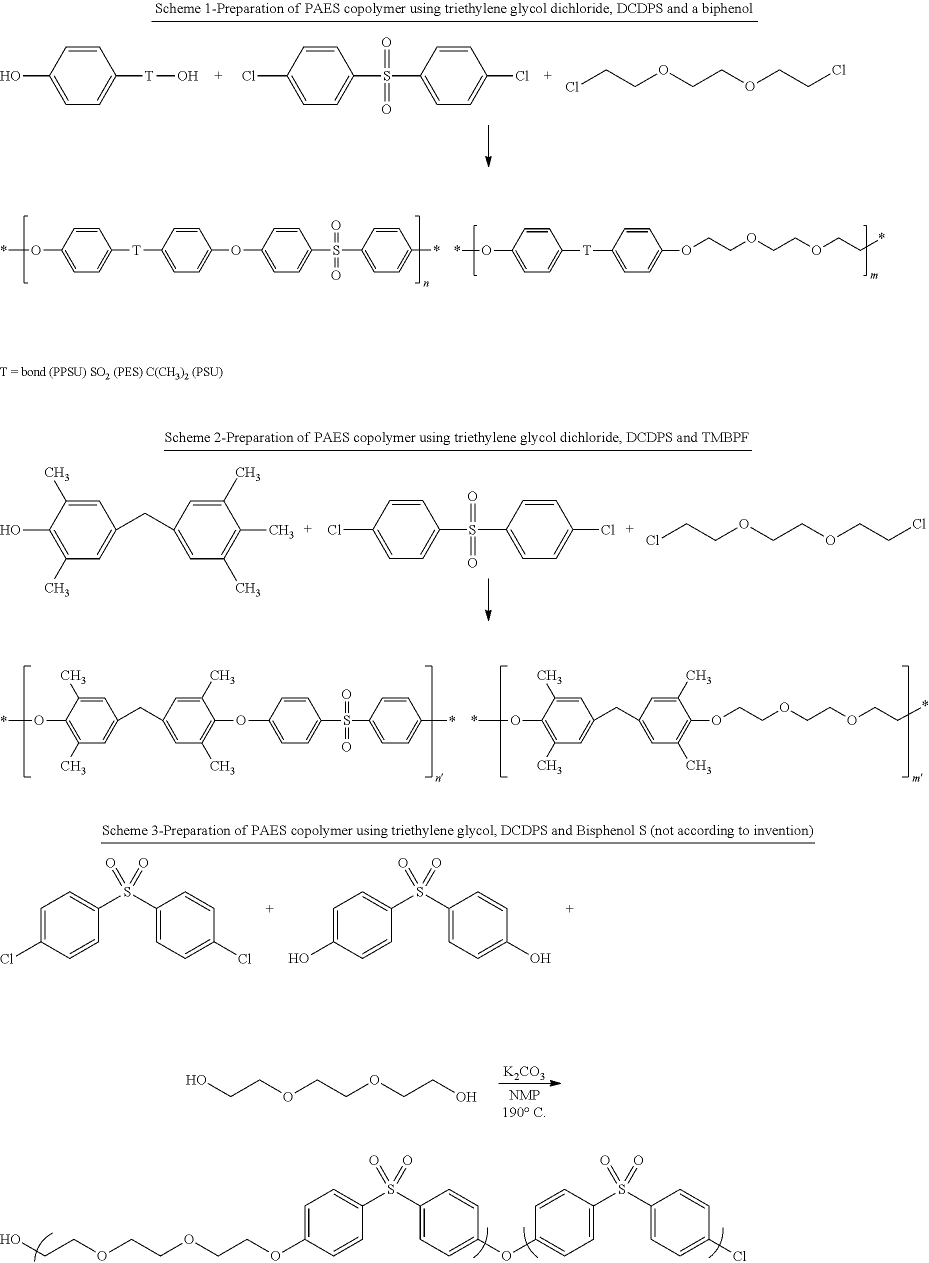

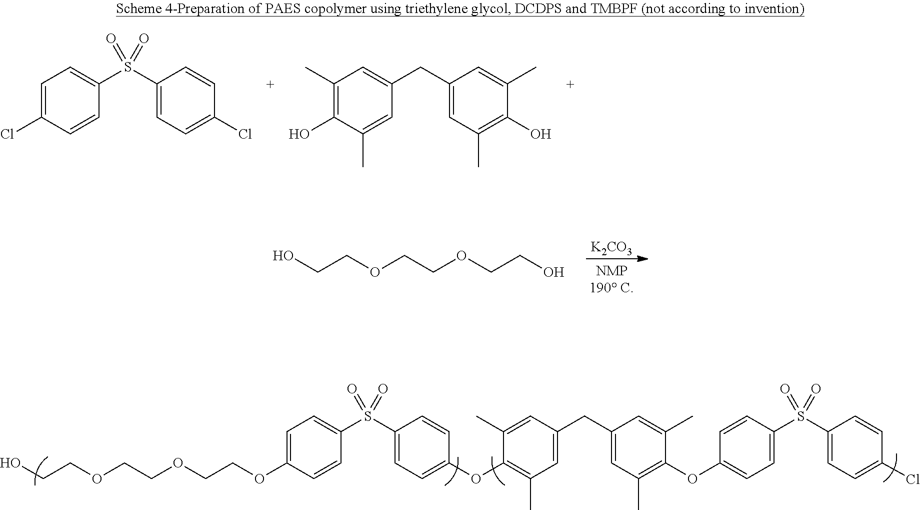

What is claimed is:

1. A polyarylethersulfone (“PAES”) copolymer comprising collectively at least 80 mol. % of recurring units (R_{AO}) and (R_{PAES}), said mol. % being based on the total number of moles of recurring units in said copolymer,
said recurring units (R_{AO}) being selected from the group consisting of units of formulae (M1), (M′1), and any combination thereof: 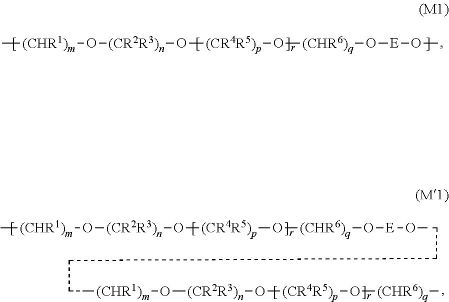
and
said recurring units (R_{PAES}) being of formula (N): 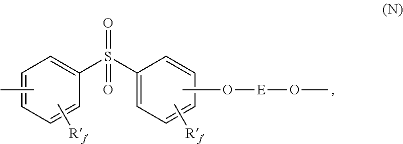
wherein the alkylene oxide moiety of the recurring units (R_{AO}) of formulae (M1) and/or (M′1) in the PAES copolymer, represented by: 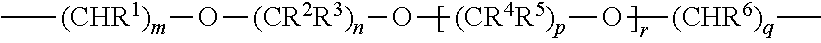
has at least 5 carbon atoms and at most 9 carbon atoms and/or at least 2 oxygen atoms and at most 4 oxygen atoms,
wherein
each of R¹, R², R³, R⁴, R⁵ and R⁶ in formulae (M1) and (M′1), is independently H or CH₃;
each of m and q is independently an integer of at least 2 and optionally at most 5, with the proviso that at least one R¹ is H and at least one R⁶ is H;
each of n and p is independently an integer of at least 1 and optionally at most 5, with the proviso that when n=2, at least one R² or R³ is H; and when p=2, at least one R⁴ or R⁵ is H;
r in formulae (M1) and (M′1) is 0, 1, 2 or 3;
each R′ in formula (N), equal to or different from each other, is selected from the group consisting of halogen, alkyl, alkenyl, alkynyl, aryl, ether, thioether, carboxylic acid, ester, amide, imide, alkali metal sulfonate, alkaline earth metal sulfonate, alkyl sulfonate, alkali metal phosphonate, alkaline earth metal phosphonate, alkyl phosphonate, amine and quaternary ammonium;
each j′ in formula (N), equal to or different from each other, are independently 0, 1, 2, 3 or 4;
-E- in formulae (N), (M1) and (M′1) is represented by at least one of following formulae (E1) to (E7): 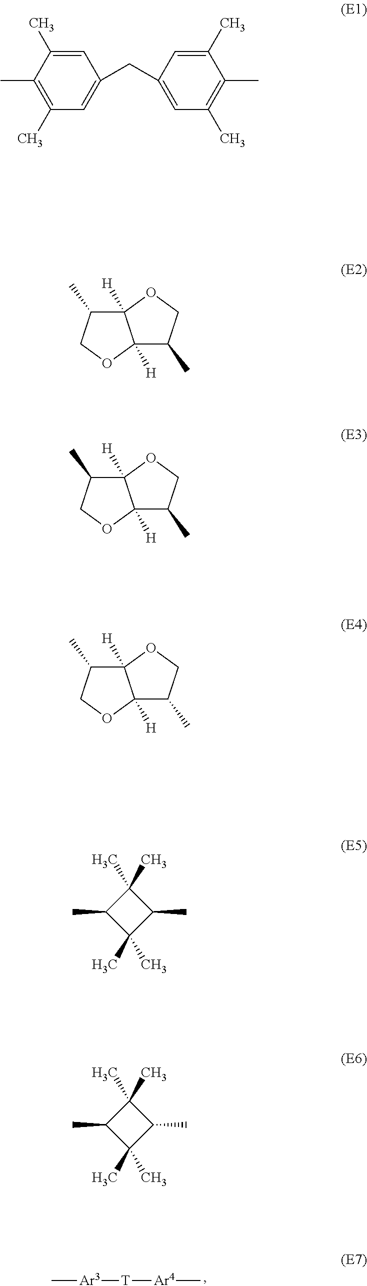
wherein
T in formula (E7) is selected from the group consisting of a bond, —SO₂—, —C(CH₃)₂—, —C(CF₃)₂—, —C(CCl₃)₂—, —C(═CCl₂)—, —CH₂—, —O—, —C(O)—, —C(CH₃)(CH₂CH₂COOH)—, —S—, and —SO—; and
Ar³ and Ar⁴, equal to or different from each other and at each occurrence in formula (E7), are independently aromatic moieties complying with any of the following formulae (J), (J′) and (J″): 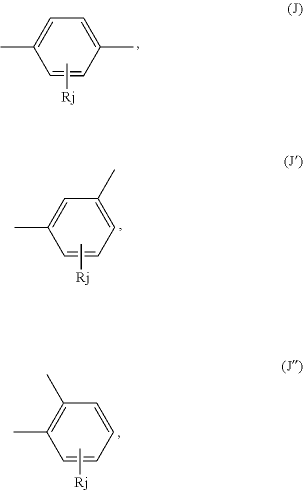
in which each R in formulae (J), (J′) and (J″), equal to or different from each other, is selected from the group consisting of halogen, alkyl, alkenyl, alkynyl, aryl, ether, thioether, carboxylic acid, ester, amide, imide, alkali metal phosphonate, alkaline earth metal sulfonate, alkyl sulfonate, alkali metal sulfonate, alkaline earth metal phosphonate, alkyl phosphonate, amine and quaternary ammonium; and
in which each j in formulae (J), (J′) and (J″), equal to or different from each other, are independently 0, 1, 2, 3 or 4; and
wherein the PAES copolymer comprises at least 4 mol. % and up to 50 mol. % of the recurring units (R_{EO}), said mol. % being based on the combined numbers of moles of recurring units (R_{AO}) and (R_{PAES}).

2. The PAES copolymer according to claim 1, wherein the recurring units (R_{PAES}) are represented by formula (N′): 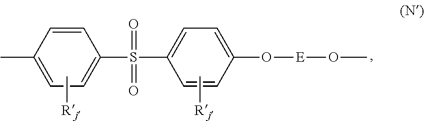
wherein
j′=0 or 1 for each R′, and when j′=1, R′ is selected from the group consisting of alkali metal sulfonates, alkaline earth metal sulfonates and alkyl sulfonates; and
-E- is represented by at least one formula selected from the group consisting of the formulae (E1) to (E6) and following formulae (E7a), (E7b) and (E7c):

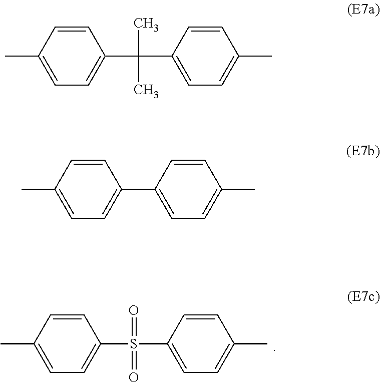

3. (canceled)

4. The PAES copolymer according to claim 1, wherein said recurring units (R_{AO}) comprise units selected from the group consisting of units of formulae (M1a) to (M1i):

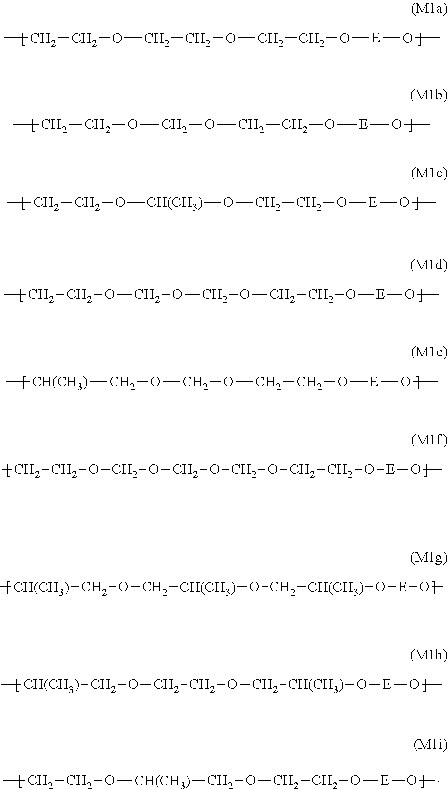

5. The PAES copolymer according to claim 1, consisting essentially of the recurring units (R_{AO}) and (R_{PAES}).

6. The PAES copolymer according to claim 1, having a Mw greater than 10,000 kDa, and optionally up to 150,000 kDa, said Mw being measured by GPC using methylene chloride as mobile phase and using polystyrene standards for calibration.

7. The PAES copolymer according to claim 1, being a random copolymer.

8. A process for making a polyarylethersulfone (“PAES”) copolymer, comprising
reacting in a reaction mixture comprising a polar aprotic solvent and in the presence of an alkali metal carbonate, a monomer mixture which contains:
at least one dihaloalkylene oxide compound [dihalo (AO) monomer, hereinafter] being selected from the group consisting of compounds of formula (I): 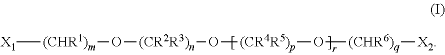
said dihalo (AO) monomer having from 5 to 9 carbon atoms in total and/or from 1 to 4 oxygen atoms in total:
at least one dihaloaryl sulfone compound [dihalo (AS) monomer, hereinafter] of formula (V): 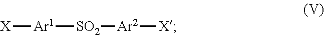
at least one dihydroxy compound [dihydroxy (B) monomer, hereinafter] being selected from the group consisting of:
tetramethyl bisphenol F,
at least one 1,4:3,6-dianhydrohexitol selected from the group consisting of isosorbide isomannide and isodide,
at least one alicyclic diol selected from the group consisting of 1,4-cyclohexanedimethanol, 1,3-cyclohexanedimethanol, 1,2-cyclohexane dimethanol, tricyclodecane dimethanol, adamantanediol, pentacyclopentadecane dimethanol, 1,3-cyclobutanediol, and 2,2,4,4-tetramethyl-1,3-cyclobutanediol (“CBDO”),
aromatic diols of formula (VI):
HO—Ar³-T-Ar⁴—OH (VI), and
any combination thereof,
wherein:
X₁ and X₂ in formula (I), equal to or different from each other, are independently a halogen atom;
each of R¹, R², R³, R⁴, R⁵ and R⁶ in formula (I) is independently H or CH₃;
each of m and q in formula (I) is independently an integer of at least 2 and optionally at most 5, with the proviso that at least one R¹ is H and at least one R⁶ is H;
each of n and p in formula (I) is independently an integer of at least 1 and optionally at most 5, with the proviso that when n=2, at least one of R² and R³ is H; and when p=2, at least one of R⁴ and R⁵ is H;
r in formula (I) is 0, 1, 2 or 3;
Ar¹ and Ar², equal to or different from each other in formula (V), and Ar³ and Ar⁴, equal to or different from each other in formula (VI), are independently aromatic moieties complying with any one of the following formulae (J), (J′) and (J″): 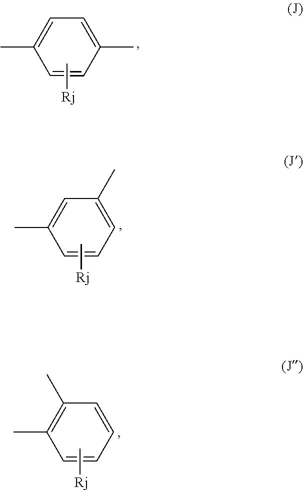
in which each R, equal to or different from each other, is selected from the group consisting of halogen, alkyl, alkenyl, alkynyl, aryl, ether, thioether, carboxylic acid, ester, amide, imide, alkali metal sulfonate, alkaline earth metal sulfonate, alkyl sulfonate, alkali metal phosphonate, alkaline earth metal phosphonate, alkyl phosphonate, amine and quaternary ammonium; and
in which each j, equal to or different from each other, are independently 0, 1, 2, 3 or 4,
X and X′, equal to or different from each other in formula (V), are independently a halogen atom;
T in formula (VI) is selected from the group consisting of a bond, —SO₂—, —C(CH₃)₂—, —C(CF₃)₂—, —C(CCl₃)₂—, —C(═CCl₂)—, —CH₂—, —O—, —C(O)—, —C(CH₃)(CH₂CH₂COOH)—, —S—, and —SO—; and
wherein
the monomer mixture contains at least 4 mol. % and up to 50 mol. % of the dihalo (AO) monomer, said mol. % being based on the combined numbers of moles of dihalo (AO) and (AS) monomers;
the overall amount of halo-groups and hydroxyl-groups of the monomers in the monomer mixture is substantially equimolecular; and
the amount of the alkali metal carbonate used in the reaction mixture, when expressed by the ratio of the equivalents of alkali metal (M) per equivalent of hydroxyl group (OH) in the dihydroxy (B) monomer [eq. (M)/eq. (OH)] is greater than 1.

9. (canceled)

10. The process according to claim 8, wherein the monomer mixture comprises at least one dihalo (AO) monomer represented by any one of the formula (Ia) to (Ii):

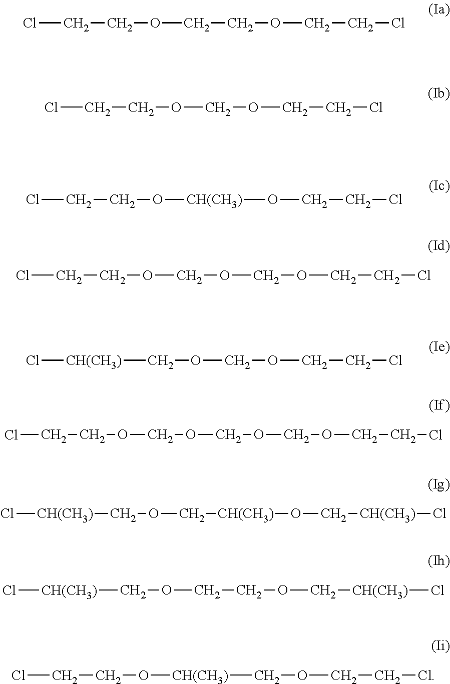

11. The process according to claim 8, wherein the monomer mixture comprises, as at least one dihalo (AS) monomer, 4,4′-dichlorodiphenylsulphone (DCDPS) and/or any sulfonated derivatives of DCDPS.

12. The process according to claim 8, wherein the monomer mixture comprises at least one dihydroxy (B) monomer selected from the group consisting of: 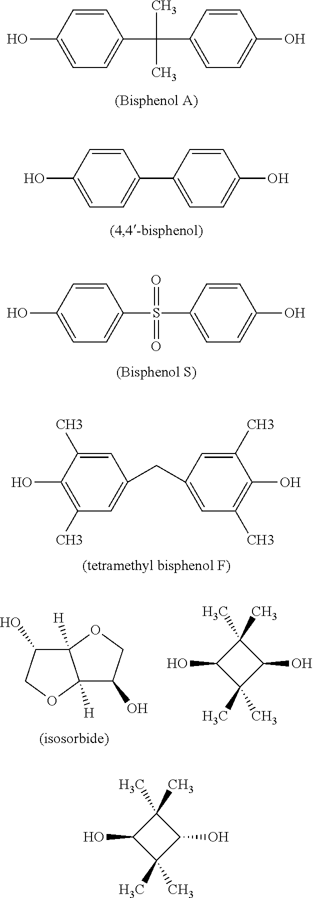
(2,2,4,4-tetramethyl-1,3-cyclobutanediol isomers)
and any combination thereof.

13. (canceled)

14. The process according to claim 8, wherein the monomer mixture contains from 10 mol. % up to 25 mol. % of the dihalo (AO) monomer, based on the combined numbers of moles of the dihydroxy monomer (B) and the dihalo (AO) and (AS) monomers.

15. The process according to claim 8, wherein the polar aprotic solvent in the reaction medium is selected from the group consisting of 1,3-dimethyl-2-imidazolidinone (DMI), dimethylsulfoxide (DMSO), dimethylsulfone (DMSO2), diphenylsulfone, diethylsulfoxide, diethylsulfone, diisopropylsulfone, tetrahydrothiophene-1,1-dioxide (also known as sulfolane), N-alkyl-2-pyrrolidone like N-Methyl-2-pyrrolidone (NMP), N-butylpyrrolidinone (NBP), N-ethylpyrrolidone (NEP), N,N′-dimethylacetamide (DMAc), N,N′-dimethylpropyleneurea (DMPU), dimethylformamide (DMF), tetrahydrothiophene-1-monoxide, and any combination thereof.

16. The process according to claim 8, wherein the reaction mixture further comprises a co-solvent which forms an azeotrope with water.

17. The process according to claim 8, wherein the alkali metal carbonate comprises potassium carbonate or sodium carbonate.

18. (canceled)

19. A method for making a porous article comprising the PAES copolymer of claim 1, using a phase inversion technique selected from non-solvent induced phase separation or thermally induced phase separation, said method comprising:
casting or spinning a polymer dope solution comprising the PAES copolymer, a solvent, optionally a co-solvent and optionally at least one pore forming agent, into the porous article, which is then cooled or contacted with a non-solvent, wherein the PAES copolymer is the sole polymer in the dope solution or wherein the dope solution further comprises at least one other polymer.

20. An article for solid state battery applications, said article comprising the PAES copolymer of claim 1.

21. An article, being porous, and being selected from a hollow fiber, hollow tube, porous film or porous membrane, said porous membrane being selected from the group consisting of hemodialysis membranes, reverse osmosis membranes, ultrafiltration membranes, microfiltration membranes, nanofiltration membranes, and ion-exchange membranes, said porous article comprising the PAES copolymer of claim 1, wherein the PAES copolymer is the sole polymer in the article or wherein the article further comprises at least one other polymer.

22. The article of claim 21, being a hemodialysis membrane, wherein the PAES copolymer is the sole polymer in the hemodialysis membrane or wherein the hemodialysis membrane further comprises at least one other polymer selected from the group consisting of PSU, sulfonated PSU, PPSU, sulfonated PPSU, PES, sulfonated PES, PDVF, and any combination thereof.

23. (canceled)

24. The article of claim 21, wherein the article is a membrane comprising a support layer or a thin selective layer, and wherein at least one of the support layer and the thin selective layer contains the PAES copolymer or is made from the PAES copolymer.

25. A method for purification of a fluid, which comprises at least a filtration step using a porous article comprising the PAES copolymer of claim 1,
said fluid being selected from an aqueous solution, water, a biological fluid and/or a food product, and
said biological fluid being selected from blood, plasma or serum.

26. (canceled)

27. (canceled)
